(19) United States
(12) Patent Application Publication
(10) Pub. No.: US 2026/0179968 A1
(43) Pub. Date: Jun. 25, 2026

(54) POSITIVE ELECTRODE PLATE AND BATTERY CELL

(71) Applicant: ZHUHAI COSMX BATTERY CO., LTD., Zhuhai (CN)

(72) Inventors: Bin LI, Zhuhai (CN); Jiao LI, Zhuhai (CN); Yuxin XIE, Zhuhai (CN); Jiajia LI, Zhuhai (CN); Baohai ZHANG, Zhuhai (CN)

(73) Assignee: ZHUHAI COSMX BATTERY CO., LTD., Zhuhai (CN)

(21) Appl. No.: 19/275,814

(22) Filed: Jul. 21, 2025

(30) Foreign Application Priority Data
Dec. 20, 2024 (CN) 202411894731.5

(51) Int. Cl. H01M 4/70; H01M 4/02; H01M 4/36; H01M 4/525; H01M 4/66; H01M 10/0525; H01M 50/426; H01M 50/434; H01M 50/443; H01M 50/446; H01M 50/449

(52) U.S. Cl. CPC H01M 4/70; H01M 4/366; H01M 4/525; H01M 4/661; H01M 10/0525; H01M 50/426; H01M 50/434; H01M 50/443; H01M 50/446; H01M 50/449; H01M 2004/021; H01M 2004/028

(57) ABSTRACT

A positive electrode plate includes a current collector with a first active material layer and a second active material layer respectively provided on two surfaces of the current collector. The first active material layer is provided with a plurality of protruding portions, and the second active material layer is provided with a plurality of recessed portions corresponding to the protruding portions. Both the first active material layer and the second active material layer include a plurality of active material particles, and particle size distribution of the active material particles satisfies: Dv10: Dv50: Dv90=1: (2˜8): (3˜16).

### CROSS-REFERENCE TO RELATED APPLICATIONS

The present application claims priority to Chinese Patent Application No. 202411894731.5, filed on Dec. 20, 2024, and the contents of the aforementioned disclosure are hereby incorporated by reference in their entireties.

### TECHNICAL FIELD

The present disclosure relates to the field of lithium-ion battery technologies, and in particular, to a positive electrode plate and a battery cell.

### BACKGROUND

With the rapid development of lithium-ion battery technologies, there are higher requirements for an energy density, a cycle life, and safety performance of a lithium-ion battery. During a charging and discharging processes of the lithium-ion battery, a negative electrode plate undergoes expansion, leading to interlayer compression between electrode plates, and the interlayer compression will result in insufficient electrolyte between layers and poor electrolyte infiltration, so that causing capacity decay of the battery, and hindering transport of lithium-ions in electrolyte-deficient regions, thereby easily inducing lithium plating formation, and thus the safety of a battery cell is affected.

### SUMMARY

In view of this, embodiments of the present disclosure provide a positive electrode plate and a battery cell to solve the technical problems of insufficient electrolyte between layers and poor electrolyte infiltration in the related art that cause battery capacity rapid decay of a battery.

To achieve the above purpose, the embodiments of the present disclosure provide the following technical solutions.

The embodiments of the present disclosure provide a positive electrode plate that includes a current collector, a first active material layer and a second active material layer. The current collector has a first surface and a second surface opposite to each other along a thickness direction of the positive electrode plate, the first active material layer is disposed on the first surface, and the second active material layer is disposed on the second surface. The first active material layer is provided with a plurality of protruding portions, and the second active material layer is provided with a plurality of recessed portions corresponding to the protruding portions. Both the first active material layer and the second active material layer include a plurality of active material particles, and the plurality of active material particles include at least one of lithium iron phosphate, lithium manganese iron phosphate, lithium n manganese phosphate, Liₐ₁Coₓ₁M1ₖ₁O₂ and Liₐ₂Niₓ₂CO_{y2}D_{z2}M2ₖ₂O₂, where, 0.85≤a1≤1.1, 0.85≤a2≤1.1, 0.85≤x1≤1.05, 0.3≤x2≤0.98, 0≤y2≤0.5, 0≤z2≤0.5, 0≤k1≤0.15, 0≤k2≤0.15, D includes at least one of Mn and Al, M1 includes at least one of Al, Mg, Ti, Zr, Y, La, W, B, Nb, and Mn, M2 includes at least one of Mg, Ti, Zr, Y, La, W, B and Nb, and a particle size distribution of the active material layer particles satisfies: Dv10: Dv50: Dv90=1: (2˜8): (3˜16).

In an embodiment of the present disclosure, Dv10 ranges from 2 μm to 8 μm; and/or Dv50 ranges from 11 μm to 19 μm; and/or Dv90 ranges from 22 μm to 32 μm.

In an embodiment of the present disclosure, the protruding portion has a first intersection point, and the first intersection point intersects with a plane where a surface of the first active material layer is located. In the thickness direction of the positive electrode plate, the first intersection point and a highest protruding point of the protruding portion have a first vertical distance H1, H1 ranges from 3 μm to 40 μm. A thickness of the current collector is a first thickness H2, H2 ranges from 6 μm to 20 μm. In the thickness direction of the positive electrode plate, both the first active material layer and the second active material layer have a second thickness H3, H3 ranges from 30 μm to 150 μm. The first vertical distance H1, the first thickness H2, the second thickness H3, and a second particle size D2 (Dv50) have a following relationship: (H1+Dv50)/(H2+2H3)=0.1˜0.8.

In an embodiment of the present disclosure, along a width direction of the positive electrode plate and a length direction of the positive electrode plate, a tensile strength M of the current collector is ≥50 MPa; and/or, the first vertical distance H1 and the tensile strength M have a following relationship: 0.05≤H1/M≤0.4.

In an embodiment of the present disclosure, the current collector has an elongation at break N1, and the elongation at break N1≥2%; and/or the first vertical distance H1 and the elongation at break N1 have a following relationship: 10≤H1/N1≤60.

In an embodiment of the present disclosure, the current collector includes an aluminum foil, the aluminum foil has an elongation rate N2, and the elongation rate N2 ranges from 0.5% to 2%.

In an embodiment of the present disclosure, the protruding portion has an arc-shaped outer surface, the arc-shaped outer surface is located on the first active material layer, and a projection of the arc-shaped outer surface in the thickness direction of the positive electrode plate has a first width R1; the recessed portion has an arc-shaped inner surface, the arc-shaped inner surface is located on the second active material layer, and a projection of the arc-shaped inner surface in the thickness direction of the positive electrode plate has a second width R2; the first width R1 and the second width R2 have a following relationship: R1/R2=1.01˜1.3; and/or the first width R1 and the first vertical distance H1 have a following relationship: R1/H1=50˜800.

In an embodiment of the present disclosure, the arc-shaped outer surface has a first area S1, the projection of the arc-shaped outer surface in the thickness direction of the positive electrode plate has a second area S2; the arc-shaped inner surface has a third area S3, the projection of the arc-shaped inner surface in the thickness direction of the positive electrode plate has a fourth area S4; and the first area S1, the second area S2, the third area S3 and the fourth area S4 have following relationships: S1/S2=1.05˜1.8; and/or S3/S4=1.1˜1.8.

In an embodiment of the present disclosure, a center interval of the projections of two adjacent protruding portions in the thickness direction of the positive electrode plate is a first distance L1. There is a straight section between two adjacent protruding portions, and the straight section has a second distance L2 in a length direction of the positive electrode plate or a width direction of the positive electrode plate. The first distance L1 and the second distance L2 have a following relationship: L1/L2=1.05˜3.

In an embodiment of the present disclosure, a first tangent line is tangent to the first intersection point, and an included angle between the first tangent line and the plane where the surface of the first active material layer is located is a first included angle a1; the recessed portion has a second intersection point, and the second intersection point intersects with a plane where a surface of the second active material layer is located; a second tangent line is tangent to the second intersection point, and an included angle between the second tangent line and a horizontal plane where the surface of the second active material layer is located is a second included angle a2; the first included angle a1 and the second included angle a2 have following relationships: a1−a2=0°˜40°; and/or the first included angle a1 ranges from 0° to 90°; and/or the second included angle a2 ranges from 0° to 90°.

In an embodiment of the present disclosure, a sum of projection areas of a plurality of protruding portions in the thickness direction of the positive electrode plate is a fifth area S11, a projection area of the electrode plate in the thickness direction of the positive electrode plate is a sixth area S, and the fifth area S11 and the sixth area S have a following relationship: S11/S=0.1˜0.95.

In an embodiment of the present disclosure, a head of the electrode plate includes a first void avoidance area, and in a length direction of the positive electrode plate, the first void avoidance area has a third width M1; the head of the positive electrode plate includes an initial bending section, and in the length direction of the positive electrode plate, the third width M1=a width of the initial bending section±10 mm; or the head of the positive electrode plate includes an initial bending section and a secondary bending section, and in the length direction of the positive electrode plate, the third width M1=a width of the initial bending section+a width of the secondary bending section±10 mm; and/or a tail of the positive electrode plate includes a double-sided coating area and a single-sided coating area that are adjacent, two surfaces of the double-sided coating area are provided with active material layers respectively, one surface of the single-sided coating area is provided with the active material layer, and the double-sided coating area and the single-sided coating area have a boundary line; and in the length direction of the electrode plate, there is a second void avoidance area between the boundary line and the protruding portion, and the second void avoidance area has a fourth width M2 ranging from 2 mm to 30 mm.

In an embodiment of the present disclosure, a shape of a projection of the protruding portion in the thickness direction of the positive electrode plate includes a circle, a semicircle, an ellipse, a plum blossom shape, or a polygon.

The embodiments of the present disclosure also provide a battery cell, which includes the above-described positive electrode plate, and also includes a separator and a negative electrode plate. The separator includes a substrate, a ceramic layer located on a side of the substrate and an adhesive layer located on the other side of the substrate, and the ceramic layer is disposed opposite to the protruding portion of the positive electrode plate.

In an embodiment of the present disclosure, the ceramic layer is an inorganic ceramic particle coating layer, an inorganic ceramic particle and polyvinylidene fluoride coating layer or an inorganic ceramic particle and polymethyl methacrylate and polyvinylidene fluoride coating layer. A content of the inorganic ceramic particles in the ceramic layer is ≥50%. The inorganic ceramic particle includes one or more of α-Al₂O₃, γ-Al₂O₃, Al₂O₃, SiO₂, CeO₂, MgAl₂O₄, ZrO, and TiO₂.

A positive electrode plate provided by the embodiments of the present disclosure has following technical effects.

According to the embodiments of the present disclosure, the plurality of protruding portions and the corresponding plurality of recessed portions are formed on the positive electrode plate, and the protruding portions are formed by a portion of the positive electrode plate protruding from a surface at a side to an opposite surface at another side. Firstly, the protruding portions are capable of effectively supporting the separator, to ensure there is sufficient space between layers of the positive electrode plate and the negative electrode plate, as well as between layers of the positive electrode plate and the separator, so that interlayer electrolyte distribution is improved, interlayer liquid storage capacity is increased, and optimal infiltration efficiency is guaranteed. and thus insufficient electrolyte infiltration during later cycling stages is avoided. Therefore, a risk of insufficient electrolyte and poor infiltration caused by the interlayer space between the positive electrode plate and the negative electrode plate inside the battery cell being repeated squeezed due to repeated expansion and contraction during charging and discharging, thereby issues that interface deterioration between the electrode plates, poor cycle stability of a negative electrode and reduction of battery capacity retention rate are improved, so that decay rate of battery capacity is reduced, and thus cycle life of the battery cell is improved.

Furthermore, the plurality of protruding portions are formed on the positive electrode plate, so that the deformation ability of the positive electrode plate is improved. When the positive electrode plate contacts with the expanded negative electrode plate, the protruding portions on the positive electrode plate may effectively absorb expansion stress of the negative electrode plate, which buffers the expansion stress of the negative electrode plate during the battery cycling process, and thus cracks caused by excessive expansion stress of the negative electrode plate are avoided. Moreover, the protruding portions disposed on the positive electrode plate absorb a portion of the expansion stress generated by the negative electrode plate, so that the negative electrode plate does not completely depend on resistance of the material thereof during expanding, thereby delaying fatigue of the negative electrode material, and thus the service life of the negative electrode plate is improved.

In addition, the particle size distribution of the active material particles in the active material layer is controlled. If the majority of the active material particles in the active material layer have an excessively large particle diameter, when the protruding portions is formed, the active material particles with the large diameter are difficult to move, which causes a height of the protruding portions is difficult to meet a requirement. In this case, it is necessary to increase the stamping pressure to make the height of the protruding portions meet the requirement, which will lead to breakage of the active material particles with the large diameter, and thus energy performance of the positive electrode plate is reduced. Moreover, increasing the stamping pressure also will cause the active material particles to crack the current collector of the positive electrode plate. Therefore, by controlling the particle size distribution of the active material particles in the active material layer, large and small particles in the active material layer are mixed, and the small particles may be filled between the large particles. During the process of manufacturing the protruding portions and recessed portions on the electrode plate, the small particles slide to two sides under a compressive force and are filled between the large particles, so that not only the active material particles are prevented from fracturing, but also the current collector is protected from being torn, and meanwhile it is ensured that the height of the protruding portion meets the predetermined requirements.

### BRIEF DESCRIPTION OF THE DRAWINGS

To more clearly illustrate embodiments of the present disclosure or technical solutions in the related art, drawings that are required to be used in description of the embodiments or the related art will be briefly introduced below. Apparently, the drawings in the following description are some embodiments of the present disclosure. For those with ordinary skill in the art, other drawings may be obtained according to these drawings without creative work.

FIG. 1 is a first schematic structural diagram of a positive electrode plate provided by an embodiment of the present disclosure.

FIG. 2 is a second schematic structural diagram of a positive electrode plate provided by an embodiment of the present disclosure.

FIG. 3 is a third schematic structural diagram of a positive electrode plate provided by an embodiment of the present disclosure.

FIG. 4 is a fourth schematic structural diagram of a positive electrode plate provided by an embodiment of the present disclosure.

FIG. 5 is a top view schematic structural diagram of a positive electrode plate provided by an embodiment of the present disclosure.

FIG. 6 is a schematic diagram of double-sided and single-sided coating of a positive electrode plate provided by an embodiment of the present disclosure.

FIG. 7 is a schematic structural diagram of a jelly roll provided by an embodiment of the present disclosure.

### DETAILED DESCRIPTION OF THE EMBODIMENTS

In a wound lithium-ion battery, an electrode assembly is formed into a wound structure of a battery cell through stacking and winding. A cross-section of the wound structure presents a flattened elliptical structure, the elliptical structure has arc areas on two sides and a planar area between the arc areas. During charging and discharging processes of the lithium-ion battery, positive and negative electrode plates will expand, the planar area expands freely upward and downward, but the arc area is constrained from expanding outward due to its structural characteristics and stress accumulation, finally leading to interlayer compression of electrode plates, and therefore, resulting in issues such as separator pore blockage, poor electrolyte infiltration and lithium plating.

Meanwhile, compression in the arc areas is transmitted to the planar area, since the planar area has already undergone compression in a hot-pressing process during manufacturing, the planar area will be squeezed very tightly, and thus leading to poor electrolyte infiltration in the planar area as well.

According to a jelly roll provided in the embodiment of the present disclosure, a positive electrode plate is formed after coating two sides of a current collector with active material a layer, and then protruding portions and corresponding recessed portions on the positive electrode plate are processed through a special roller. The combination of the protruding portions and the recessed portions provides support for separator contact, and increases micro-gaps between the positive electrode plate and the separator. These micro-gaps form spaces that accommodate electrolyte, so that sufficient electrolyte infiltrates into the electrode plates, and thus occurrence of abnormal situations such as insufficient electrolyte between the electrode plate and the separator and poor infiltration, and even lithium plating on a negative electrode plate due to interlayer compression of the electrode plates is avoided.

However, during manufacturing the protruding portions and the recessed portions on the positive electrode plate through the special roller, it is prone to causing the electrode plate to break, so that a production efficiency and a process yield are seriously affected.

By controlling particle size distribution of active material particles in the active material layers, large and small particles in the active material layers are mixed, and the small particles are filled between the large particles. During the process of manufacturing the protruding portions and the recessed portions on the positive electrode plate, the small particles slide to two sides under a compressive force and are filled between the large particles, so that not only the active material particles are prevented from fracturing, but also the current collector is protected from being torn, and meanwhile it is ensured that a height of the protruding portions meets a predetermined requirement.

To make the above objectives, features, and advantages of the embodiments of the present disclosure more obvious and easier to understand, technical solutions in the embodiments of the present disclosure will be clearly and completely described below with reference to drawings in the embodiments of the present disclosure. Apparently, the described embodiments are merely a portion of the embodiments of the present disclosure, rather than all of the embodiments. Based on the embodiments in the present disclosure, all other embodiments obtained by those with ordinary skill in the art without creative work shall fall within the protection scope of the present disclosure.

In the embodiments of the present disclosure, a thickness direction of an electrode plate is a z-axis shown in the figure, a length direction of the electrode plate is an x-axis shown in the figure, and a width direction of the electrode plate is a y-axis shown in the figure.

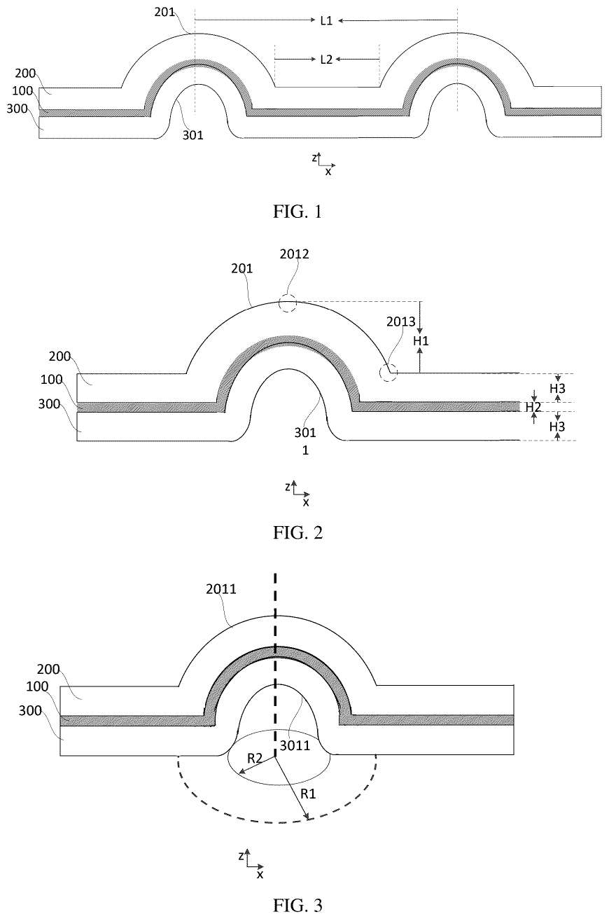

With reference to FIG. 1, a positive electrode plate provided by the embodiments of the present disclosure includes a current collector 100, a first active material layer 200 and a second active material layer 300.

The current collector 100 has a first surface and a second surface opposite to each other along a thickness direction of the positive electrode plate (a z-axis shown in the figure), the first active material layer 200 is disposed on the first surface, and the second active material layer 300 is disposed on the second surface.

The first active material layer 200 is provided with a plurality of protruding portions 201, and the second active material layer 300 is provided with a plurality of recessed portions 301 corresponding to the protruding portions 201.

The protruding portions 201 corresponding to the recessed portions 301 refers to that a projection of the protruding portion 201 along the thickness direction of the positive electrode plate (the z-axis shown in the figure) covers a projection of the recessed portion 301 along the thickness direction of the positive electrode plate.

The protrusion portions 201 and the recessed portions 301 are respectively provided on the first active material layer 200 and the second active material layer 300 which are coated on both surfaces of the current collector 100, which provide support for separator contact, and increase micro-gaps between the positive electrode plate and the separator. These micro-gaps form spaces that may accommodate electrolyte, so that sufficient electrolyte infiltration into the electrode plate, and thus the occurrence of abnormal situations such as insufficient electrolyte between the electrode plate and the separator and poor infiltration, and even lithium plating on a negative electrode plate due to interlayer compression of the electrode plate is avoided.

Both the first active material layer 200 and the second active material layer 300 include a plurality of active material particles, and the plurality of active material particles include at least one of lithium iron phosphate, lithium manganese iron phosphate, lithium manganese phosphate, Liₐ₁Coₓ₁M1ₖ₁O₂, and Liₐ₂Niₓ₂CO_{y2}D_{z2}M2ₖ₂O₂.

Among them, 0.85≤a1≤1.1, 0.85≤a2≤1.1, 0.85≤x1≤1.05, 0.3≤x2≤0.98, 0≤y2≤0.5, 0≤z2≤0.5, 0≤k1≤0.15, 0≤k2≤0.15.

D includes at least one of Mn and Al.

M1 includes at least one of Al, Mg, Ti, Zr, Y, La, W, B, Nb and Mn.

M2 includes at least one of Mg, Ti, Zr, Y, La, W, B and Nb.

Particle size distribution of the plurality of active material layer particles satisfies: Dv10: Dv50: Dv90=1: (2˜8): (3˜16).

Preferably, Dv10: Dv50: Dv90=1: (2˜7): (5˜13).

Among them, Dv10 represents a particle diameter at which cumulative volume reaches 10% in the volume-based particle size distribution; Dv50 represents a particle diameter at which cumulative volume reaches 50% in the volume-based particle size distribution; Dv90 represents a particle diameter at which cumulative volume reaches 90% in the volume-based particle size distribution.

In other words, the first active material layer 200 and the second active material layer 300 respectively contain a mixture of large and small particles, and the small particles are filled between the large particles. When manufacturing the protruding portions 201 and the recessed portions 301 on the positive electrode plate, the small particles slide to two sides under a compressive force and are filled between the large particles, so that not only the active material particles are prevented from fracturing, but also the current collector is protected from being torn, and meanwhile it is ensured that a height of the protruding portions 201 meets a predetermined requirement.

When Dv10 remains constant, a ratio of Dv50 to Dv10 is greater than 8, and a ratio of Dv90 to Dv10 is greater than 16, compared to the particle diameter at which the cumulative volume reaches 10%, the particle diameter at which the cumulative volume reaches 50% is excessively large, and similarly, the particle diameter at which the cumulative volume reaches 90% is also excessively large. This indicates that the majority of the active material particles in the active material layer have an excessively large particle diameter. When manufacturing the protruding portions 201 on the positive electrode plate, the active material particles a large diameter are difficult to move, resulting in an insufficient height of the protruding portion 201, an insufficient depth of the recessed portion 301 and poor electrolyte infiltration. Under the premise that the particle diameters of the majority of the active material particles are excessively large, in order to make the height of the protruding portion 201 meet the requirements, it is necessary to increase the stamping pressure, which will cause the large-diameter active material particles to break, and so that energy performance of the positive electrode plate is reduced. At the same time, the higher stamping pressure will also cause the active material layer particles to squeeze and crack the current collector 100 of the positive electrode plate.

When Dv10 remains constant, the ratio of Dv50 to Dv10 is less than 2, and the ratio of Dv90 to Dv10 is less than 3, it indicates that there is a small particle diameter difference between the particle diameter at which the cumulative volume reaches 10%, 50% and 90%, and so that the desired effect of mixing the large and small particles cannot be achieved. Relatively smaller particles slide to two sides under the compressive force, the current collector of the positive electrode plate is directly subjected to the pressure, which is easy to cause on the current collector 100 of the positive electrode plate to be subjected to excessive pressure, and so that it is fractured.

In an embodiment of the present disclosure, Dv10 ranges from 2 μm to 8 μm, it indicates that among the plurality of active material layer particles, the particle diameter at which the cumulative volume reaches 10% ranges from 2 μm to 8 μm; and preferably, Dv10 ranges from 2 μm to 7 μm.

Dv50 ranges from 11 μm to 19 μm, it indicates that among the plurality of active material layer particles, the particle diameter at which the cumulative volume reaches 50% ranges from 11 μm to 19 μm; and preferably, Dv50 ranges from 12 μm to 16 μm.

Dv90 ranges from 22 μm to 32 μm, it indicates that among the plurality of active material layer particles, the particle diameter at which the cumulative volume reaches 90% ranges from 22 μm to 32 μm; and preferably, Dv90 ranges from 24 μm to 32 μm.

When Dv50 ranges from 11 μm to 19 μm, Dv90 ranges from 22 μm to 32 μm, but Dv10 is greater than 8 μm, it indicates that the particle diameter of the small particles is excessively large, and the majority of the active material particles in the active material layer have an excessively large particle diameter. When manufacturing the protruding portions 201 on the positive electrode plate, the active material particles with a large diameter are difficult to move, resulting in an insufficient height of the protruding portions 201, and an insufficient depth of the recessed portions 301 and poor electrolyte infiltration. In order to ensure the height of the protruding portions 201, continued stamping may also cause the active material particles with the large diameter to break, and the relatively higher stamping pressure may also cause the active material layer particles to squeeze and crack the current collector 100 of the positive electrode plate.

When Dv50 ranges from 11 μm to 19 μm, Dv90 ranges from 22 μm to 32 μm, but Dv10 is less than 2 μm, it indicates that the particle diameter of the small particles is excessively small, and the presence of the small particles is meaningless. The majority of the active material particles in the active material layer have a large particle diameter, and the active material particles with the large diameter are difficult to move, resulting in an insufficient height of the protruding portions 201, and an insufficient depth of the recessed portions 301 and poor electrolyte infiltration. In order to ensure the height of the protruding portions 201, continued stamping may also cause the active material particles with the large diameter to break, and the relatively higher stamping pressure may also cause the active material layer particles to squeeze and crack the current collector 100 of the positive electrode plate.

When Dv10 ranges from 2 μm to 8 μm, Dv90 ranges from 22 μm to 32 μm, but Dv50 is greater than 19 μm, it indicates that the particle diameter of the large particles is excessively large, and the majority of the active material particles in the active material layer have a large particle diameter. When manufacturing the protruding portions 201 on the positive electrode plate, the active material particles with the large diameter are difficult to move, resulting in an insufficient height of the protruding portions 201, and an insufficient depth of the recessed portions 301 and poor electrolyte infiltration. In order to ensure the height of the protruding portions 201, continued stamping may also cause the active material particles with the large diameter to break, and the relatively higher stamping pressure may also cause the active material layer particles to squeeze and crack the current collector 100 of the positive electrode plate.

When Dv10 ranges from 2 μm to 8 μm, Dv90 ranges from 22 μm to 32 μm, but Dv50 is less than 11 μm, it indicates that the particle diameter of the large particles is excessively small, and the majority of the active material particles in the active material layer have a small diameter, which causes a greater packing density of the active material particles in both the first active material layer 200 and the second active material layer 300, and correspondingly there are less pores. When the small particles with the relatively smaller diameter particles slide to two sides under the compressive force, there is insufficient filling space, which will cause the active material particles to break, and so that the energy performance of the positive electrode plate is reduced. At the same time, it may also cause the active material layer particles to squeeze and crack the current collector 100 of the positive electrode plate.

When Dv10 ranges from 2 μm to 8 μm, Dv50 ranges from 11 μm to 19 μm, but Dv90 is greater than 32 μm, it indicates that the particle diameter of the large particles is excessively large, and the particle diameter of the majority of the active material particles in the active material layer is excessively large. When manufacturing the protruding portions 201 on the positive electrode plate, the active material particles with the large diameter are difficult to move, resulting in an insufficient height of the protruding portions 201, an insufficient depth of the recessed portions 301 and poor electrolyte infiltration. In order to ensure the height of the protruding portions 201, continued stamping may also cause the active material particles with the large diameter to break, and relatively higher stamping pressure may also cause the active material layer particles to squeeze and crack the current collector 100 of the positive electrode plate.

When Dv10 ranges from 2 μm to 8 μm, Dv50 ranges from 11 μm to 19 μm, but Dv90 is less than 22 μm, it indicates that the particle diameter of the large particles is excessively small, and the majority of the active material particles in the active material layer have a small particle diameter, which causes a greater packing density of the active material particles in both the first active material layer 200 and the second active material layer 300, and so that correspondingly there are less pores. When the small particles with the relatively particle smaller diameter slide to two sides under compressive force, there is an insufficient filling space, which will cause the active material particles to break, and so that the energy performance of the positive electrode plate is reduced. At the same time, it may also cause the active material layer particles to squeeze and crack the current collector 100 of the positive electrode plate.

With reference to FIG. 2, in an embodiment of the present disclosure, the protruding portion 201 has a first intersection point 2013, and the first intersection point 2013 intersects with a plane where a surface of the first active material layer 200 is located. In the thickness direction of the positive electrode plate (the z-axis shown in the figure), the first intersection point 2013 and a highest protruding point 2012 of the protruding portion 201 have a first vertical distance H1, the first vertical distance H1 ranges from 3 μm to 40 μm. In an example, the first vertical distance H1 ranges from 3 μm to 30 μm.

The first vertical distance H1 represents a height of the protruding portion 201, by limiting the height of the protruding portion 201, an appropriate gap may be formed between the electrode plate and the separator, so that structural support is provided, and an excessively large thickness of the electrode plate is avoided.

When the first vertical distance H1 is less than 3 μm, it indicates that the protruding portion 201 is excessively short, so that the supporting effect is not obvious, and thus the protruding portion 201 is considered as an invalid protruding portion, and sufficient electrolyte infiltration cannot be ensured. When the first vertical distance H1 is greater than 40 μm, it indicates that the protruding portion 201 is excessively high, resulting in severe delamination between the positive and negative electrode plates, and thus new interface issues are caused.

A thickness of the current collector 100 is a first thickness H2, H2 ranges from 6 μm to 20 μm. In an example, H2 ranges from 8 μm to 18 μm.

In the thickness direction of the positive electrode plate (the z-axis shown in the figure), both the first active material layer 200 and the second active material layer 300 have a second thickness H3, H3 ranges from 30 μm to 150 μm. The first vertical distance H1, the first thickness H2, the second thickness H3 and Dv50 have a following relationship: (H1+Dv50)/(H2+2H3)=0.1˜0.8. In an example, (H1+Dv50)/(H2+2H3)=0.3˜0.5.

The above relationship enables to better balance the height of the protruding portion 201, so that damage to the current collector 100 and particles breakage is avoided. Among them, H2+2H3 refers to a total thickness of the electrode plate, and H1+Dv50 represents a height of an apex of the protruding portion. When (H1+Dv50)/(H2+2H3) is greater than 0.5, the height of the apex of the protruding portion 201 is excessively high, and it indicates that the particle diameter of the large particles is excessively large and numerous, which will easily cause damage to the positive electrode plate and breakage of the particles during embossing of the positive electrode plate. Moreover, the excessively large particles at the apex of the protruding portion are also prone to powder shedding. When (H1+Dv50)/(H2+2H3) is less than 0.3, the height of the protruding portion 201 is too small to meet the infiltration effect, or it indicates that Dv50 is excessively small, so that ultimate compaction of the material is excessively small, and thus it is difficult to ensure the height of the protruding portion 201.

In an embodiment of the present disclosure, along a width direction (a y-axis shown in the figure) and a length direction (an x-axis shown in the figure) of the positive electrode plate, a tensile strength M of the current collector 100 is ≥50 MPa. The higher the height of the protruding portion 201, the greater the compressive force it applying to the current collector 100, so that the tensile strength M of the current collector 100 should be greater, and therefore, when the tensile strength M≥50 MPa, it is capable of preventing the current collector 100 from breaking.

The first vertical distance H1 and the tensile strength M have a following relationship: 0.05≤H1/M≤0.4. In an example, 0.1≤H1/M≤0.2.

The first vertical distance H1 represents the height of the protruding portion 201, the higher the height of the protruding portion 201, the greater the compressive force it applying to the current collector 100. Therefore, by limiting the relationship between the height of the protruding portion 201 and the tensile strength of the current collector 100, the current collector 100 is prevented from breaking.

When H1/M is greater than 0.4, it indicates that the protruding portion 201 is excessively high and the tensile strength of the current collector 100 is insufficient, so that the compressive force that the protruding portion 201 applies to the current collector 100 is greater, and thus it is easy to cause the current collector 100 to break. When H1/M is less than 0.05, it indicates that the protruding portion 201 is excessively short, the supporting effect is not obvious, so that the protruding portion 201 is an invalid protruding portion, and thus sufficient infiltration of the electrolyte cannot be ensured.

In an embodiment of the present disclosure, the current collector 100 has an elongation at break N1, and the elongation at break N1≥2%. The greater the elongation at break N1 of the current collector 100, the better a ductility of the current collector 100, so that the elongation at break N1≥2% is capable of preventing the current collector from breaking.

In an embodiment of the present disclosure, the first vertical distance H1 and the elongation at break N1 have a following relationship: 10≤H1/N1≤60. In an example, 15≤H1/N1≤ 50.

The higher the height of the protruding portion 201, the greater the compressive force it applying to the current collector 100. Therefore, by limiting the relationship between the height of the protruding portion 201 and the elongation at break N1 of the current collector 100, the current collector 100 is prevented from breaking.

When H1/N1 is greater than 60, it indicates that the protruding portion 201 is excessively high and the ductility of the current collector 100 is insufficient, so that the compressive stress that the protruding portion 201 applies to the current collector 100 is greater, so that it is easy to cause the current collector 100 to break. When H1/N1 is less than 10, it indicates that the protruding portion 201 is excessively short, so that the supporting effect is not obvious, thereby the protruding portion 201 is an invalid protruding portion, and thus sufficient infiltration of the electrolyte cannot be ensured.

In an embodiment of the present disclosure, the current collector 100 includes an aluminum foil, the aluminum foil is provided with a pore structure, a concave-convex structure or a carbon material.

Among them, the aluminum foil is provided with the pore structure refers to that there are pores punched on the aluminum foil to increase a coating amount of active material layer. At the same time, it is capable of enhancing adhesion between the active material layer and the current collector 100, so that the active material layer is prevented from detaching from the current collector 100 when manufacturing the protruding portion 201.

The concave-convex structure is disposed on the aluminum foil refers to that a special roller is used for rolling the current collector 100 to form the plurality of concave-convex structures on the current collector 100. The concave-convex structure increases a contact area between the active material layer and the current collector 100, thereby enhancing the adhesion between the active material layers and the current collector 100, so that the active material layer is prevented from detaching from the current collector 100 when manufacturing the protruding portion 201.

The carbon material is disposed on the aluminum foil to obtain a carbon-containing aluminum foil which is capable of enhancing the adhesion between the active material layer and the current collector 100, so that the active material layer is prevented from detaching from the current collector 100 when manufacturing the protruding portion 201.

Among them, a thickness of the aluminum foil is also the thickness of the current collector 100, and the thickness of the current collector 100, in other words, the first thickness H2 ranges from 6 μm to 20 μm.

In an embodiment of the present disclosure, the aluminum foil has an elongation rate N2, and the elongation rate N2 ranges from 0.5% to 2%. In an example, the elongation rate N2 ranges from 1% to 2%.

When manufacturing the protruding portion 201, the aluminum foil will be subjected to the compressive force. By limiting the elongation rate N2 of the aluminum foil, it is ensured that the aluminum foil will sufficiently withstand an elongation caused by manufacturing the protruding portion 201, so that the aluminum foil is prevented from breaking when the active material particles compress the aluminum foil.

With reference to FIG. 3, in an embodiment of the present disclosure, the protruding portion 201 has an arc-shaped outer surface 2011, the arc-shaped outer surface 2011 is located on the first active material layer 200, and a projection of the arc-shaped outer surface 2011 in the thickness direction of the electrode plate (the z-axis shown in the figure) has a first width R1. The recessed portion 301 has an arc-shaped inner surface 3011, the arc-shaped inner surface 3011 is located on the second active material layer 300, and a projection of the arc-shaped inner surface 3011 in the thickness direction of the electrode plate (the z-axis shown in the figure) has a second width R2.

The first width R1 and the second width R2 have a following relationship: R1/R2=1.01˜1.3. In an example, R1/R2=1.01˜1.1.

By limiting a ratio of the first width R1 to the second width R2, the sharpness of the protruding portion 201 is limited, so that damage to the electrode plate caused by the protruding portion 201 is avoided.

The first width R1 ranges from 0.5 mm to 8 mm. In an example, the first width R1 ranges from 1 mm to 4 mm.

When the first width R1 is less than 0.5 mm, a width of the protruding portion 201 is insufficient, so that the supporting effect is not obvious, and thus the negative electrode expansion cannot be effectively improved. When the first width R1 is greater than 8 mm, the width of the protruding portion 201 is excessively large, so that the protruding portion 201 is easily subjected to the compressive force, an elongation force and a cyclic expansion force during manufacturing process, thereby causing excessive deformation of the protruding portion 201, therefore resulting in collapse of the protruding portion 201, and thus failing to effectively improve the negative electrode expansion.

The second width R2 ranges from 0.5 mm to 8 mm. In an example, the second width R2 ranges from 0.8 mm to 4 mm.

When the second width R2 is less than 0.5 mm, a width of the recessed portion 301 is excessive small, resulting in that there is an insufficient space to accommodate the electrolyte, and so that infiltration effect of the electrolyte will not be effectively improved. When the second width R2 is greater than 8 mm, the width of the recessed portion 301 is excessively large, the recessed portion 301 is easily subjected to the compressive force, the elongation force, and the cyclic expansion force during manufacturing process, thereby causing excessive deformation of the recessed portion 301, therefore resulting in collapse of the recessed portion 301, and thus failing to effectively improve the electrolyte infiltration effect.

In an embodiment of the present disclosure, the first width R1 and the first vertical distance H1 have a following relationship: R1/H1=50˜800. In an example, R1/H1=100˜300.

By limiting a projection width of the protruding portion 201 and the height of the protruding portion 201, an appropriate gap between the electrode plate and a separator is achieved, that is, the protruding portion 201 has an appropriate deformation space and liquid storage space, so that sufficient structural support is provided, and thus benefit is maximized.

When the projection width of the protruding portion 201 is small but the height of the protruding portion 201 is high, the protruding portion 201 is relatively sharp, which may easily cause damage to the electrode plate, so that safety of a battery is affected.

When the projection width of the protruding portion 201 is large and the height of the protruding portion 201 is high, the protruding portion 201 is relatively sharp and occupies an excessively large space, so that extension strength of the positive electrode plate is exceeded, thereby the extension strength of the positive electrode plate is insufficient to withstand the deformation of the protruding portion 201, and thus will easily cause the positive electrode plate to break.

When the projection width of the protruding portion 201 is large but the height of the protruding portion 201 is low, the structural support of the protruding portion 201 is insufficient, so that the protruding portion 201 is prone to excessive deformation under compressive force and an extension force during the manufacturing process, and thus the protruding portion 201 tends to be flatten. Therefore, this results in collapse of the protruding portion 201, so that the electrolyte infiltration effect, the liquid storage capacity and the negative electrode expansion will not be improved.

When the projection width of the protruding portion 201 is small and the height of the protruding portion 201 is low, the structural support of the protruding portion 201 is insufficient, and the protruding portion 201 occupies a small space, so that the electrolyte infiltration effect, the liquid storage capacity, and the negative electrode expansion is not well improved.

Continuing referring to FIG. 3, in an embodiment of the present disclosure, the arc-shaped outer surface 2011 has a first area S1, the projection of the arc-shaped outer surface 2011 in the thickness direction of the positive electrode plate (the z-axis shown in the figure) has a second area S2, the arc-shaped inner surface 3011 has a third area S3, and the projection of the arc-shaped inner surface 3011 in the thickness direction of the positive electrode plate has a fourth area S4.

The first area S1 and the second area S2 have a following relationship: S1: S2=1.05˜1.8. In an example, S1: S2=1˜1.4.

By limiting the above ratio, a volume of the protruding portion 201 is better controlled, so that the positive electrode plate has an appropriate deformation space, thereby improving the cycle performance of the battery, and thus a better improvement effect is achieved.

When the first area S1 is large but the second area S2 is small, it indicates that the height of the protruding portion 201 is relatively high, which will easily cause damage to the positive electrode plate and the particles to break.

When the first area S1 is large and the second area S2 is large, it indicates that the height of the protruding portion 201 is low, so that the structural support of the protruding portion 201 is insufficient, thereby the protruding portion 201 is prone to excessive deformation under a compressive force and an extension force during the manufacturing process, and thus the protruding portion 201 tends to be flatten. Therefore, this causes collapse of the protruding portion 201, so that the electrolyte infiltration effect, the liquid storage capacity and the negative electrode expansion will not be improved.

When the first area S1 is small but the second area S2 is large, it indicates that the height of the protruding portion 201 is relatively low, so that the structural support of the protruding portion 201 is insufficient, thereby the protruding portion 201 is prone to excessive deformation under the compressive force and the extension force during the manufacturing process, and thus the protruding portion 201 tends to be flatten. Therefore, this causes the collapse of the protruding portion 201, so that the electrolyte infiltration effect, liquid storage capacity, and the negative electrode expansion will not be improved.

When the first area S1 is small and the second area S2 is small, it indicates that the height of the protruding portion 201 is relatively low, so that the protruding portion 201 occupies a small space, and thus the electrolyte infiltration effect, the liquid storage capacity and the negative electrode expansion is not better improved.

The third area S3 and the fourth area S4 have a following relationship: S3: S4=1.1˜1.8; and preferably, S3: S4=1.2˜1.4.

By limiting the above ratio, a volume of the recessed portion 301 is better controlled, so that the electrolyte infiltration effect and the liquid storage capacity is effectively improved.

When the third area S3 is large but the fourth area S4 is small, it indicates that the height of the recessed portion 301 is relatively high, so that it is easy to cause damage to the electrode plate and the particles to break.

When the third area S3 is large and the fourth area S4 is large, it indicates that the height of the recessed portion 301 is low, so that the recessed portion 301 is prone to excessive deformation under the compressive force and the extension force during the manufacturing process, and thus the recessed portion 301 tends to be flatten. Therefore, this causes collapse of the recessed portion 301, so that the electrolyte infiltration effect and the liquid storage capacity will not be improved.

When the third area S3 is small but the fourth area S4 is large, it indicates that the height of the recessed portion 301 is relatively low, so that the recessed portion 301 is prone to excessive deformation under the compressive force and the extension force during the manufacturing process, and thus the recessed portion 301 tend to be flatten. Therefore, this causes collapse of the recessed portion 301, so that the electrolyte infiltration effect and the liquid storage capacity will not be improved.

When the third area S3 is small and the fourth area S4 is small, it indicates that the height of the recessed portion 301 is relatively low, so that the recessed portion 301 occupies a small space, and thus the electrolyte infiltration effect, the liquid storage capacity and the negative electrode expansion are not better improved.

With reference to FIG. 1, in an embodiment of the present disclosure, a center interval of projections of two adjacent protruding portions 201 in the thickness direction of the positive electrode plate (the z-axis shown in the figure) is a first distance L1. There is a straight section between two adjacent protruding portions 2021, and the straight section has a second distance L2 in a length direction or a width direction of the positive electrode plate.

The first distance L1 and the second distance L2 have a following relationship: L1/L2=1.05˜3. In an example, L1/L2=1.1˜2.

The limitation on a ratio of the first distance L1 to the second distance L2 is equivalent to the limitation on a density level of the protruding portions 201, so that it is ensured that there is appropriate spacing between the plurality of protruding portions 201, and thereby allowing the protruding portions 201 to be adjusted to an appropriate volume for providing a sufficient support force for the electrode plate and allowing the electrode plate to have an enough deformation space to alleviate expansion.

The first distance L1 ranges from 2 mm to 10 mm. In an example, the first distance L1 ranges from 3 mm to 8 mm.

The second distance L2 ranges from 0.5 mm to 8 mm. In an example, the second distance L2 ranges from 1 mm to 4 mm.

When the first distance L1 is less than 2 mm, the protruding portions 201 are excessively dense, so that the extension of the positive electrode plate cannot meet the density level of the protruding portions 201, thereby the protruding portions 201 cannot be adjusted to an appropriate volume and the height of the protruding portions 201 does not meet the requirement, and thus resulting in a less deformation space, and the positive electrode plate is prone to breaking. When the first distance L1 is greater than 10 mm, the protruding portions 201 are excessively sparse, so that the protruding portions 201 are excessively dispersed and the support area of the protruding portions 201 is insufficient, and thus the electrolyte infiltration effect and improvement effect will not be achieved.

Similarly, when the second distance L2 is less than 0.5 mm, the protruding portions 201 are excessively dense, so that the extension of the positive electrode plate cannot meet the density level of the protruding portions 201, thereby the protruding portions 201 cannot be adjusted to the appropriate volume and the height of the protruding portions 201 does not meet the requirement, and thus resulting in a less deformation space and the electrode plate is prone to breaking. When the second distance L2 is greater than 8 mm, the protruding portions 201 are excessively sparse, so that the protruding portions 201 are excessively dispersed and the support area of the protruding portions 201 is insufficient, and thereby the electrolyte infiltration effect and the improvement effect will not be achieved.

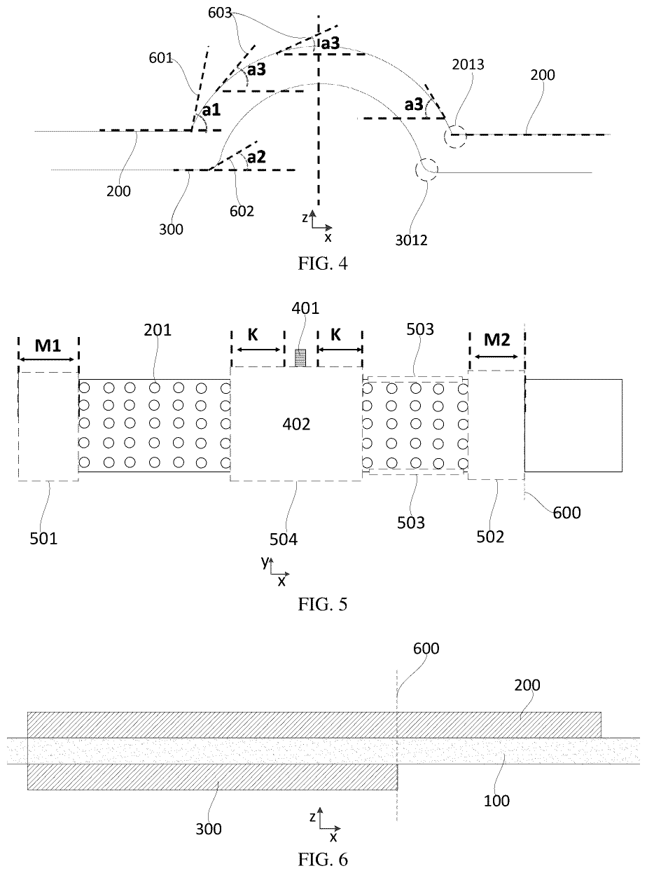

With reference to FIG. 4, in an embodiment of the present disclosure, a first tangent line 601 is tangent to the first intersection point 2013, and an included angle between the first tangent line 601 and the plane where the surface of the first active material layer 200 is located is a first included angle a1. The recessed portion 301 has a second intersection point 3012, and the second intersection point 3012 intersects with a plane where a surface of the second active material layer 300 is located. A second tangent line 602 is tangent to the second intersection point 3012, and an included angle between the second tangent line 602 and a horizontal plane where the surface of the second active material layer 300 is located is a second included angle a2.

The first included angle a1 and the second included angle a2 have a following relationship: a1−a2=0°˜40°. In an example, a1−a2=5°˜25°.

The first included angle a1 ranges from 0° to 90°. In an example, the first angle a1 ranges from 25° to 80°.

The second included angle a2 ranges from 0° to 90°. In an example, the second angle a2 ranges from 5° to 55°.

The limitation on the first included angle a1 is equivalent to the limitation on the height and a tilt angle of the protruding portion 201. When the first included angle a1 is greater than 90°, the protruding portion 201 is excessively bent, so that the connection position between the protruding portion 201 and a straight section will break. When the first included angle a1 is less than 0°, the protruding portion 201 tends to be flatten, the height of the protruding portion 201 is insufficient, so that resulting in an insufficient support force of the protruding portion 201, and thus the protruding portion 201 is easily flattened during the manufacturing process and the cycle process.

The limitation on the second included angle a2 is equivalent to the limitation on a height and a tilt angle of the recessed portions 301. When the second included angle a2 is greater than 90°, the connection position between the recessed portion 301 and the straight section is prone to breaking. When the second included angle a2 is less than 0°, the recessed portion 301 tends to be flatten, so that the recessed portion 301 occupies a small space, and thus the electrolyte infiltration effect and the liquid storage capacity will not be improved.

Theoretically, when manufacturing the protruding portion 201, the second included angle a2 is located on a compression side, and the second included angle a2 is less than the first included angle a1, so that breakage at the connection position between the recessed portion 301 and the straight section is avoided.

In an embodiment of the present disclosure, a sum of projection areas of the plurality of protruding portions 201 in the thickness direction of the positive electrode plate (the z-axis shown in the figure) is a fifth area S11, and a projection area of the electrode plate in the thickness direction of the positive electrode plate is a sixth area S.

The fifth area S11 and the sixth area S have a following relationship: S11/S=0.1˜0.95. In an example, S11/S=0.3˜0.8.

Each protruding portion 201 provides a support point, so that a plurality of support points may disperse the expansion stress of the negative electrode plate to some extent. By limiting the above ratio relationship, a contact area between the support points of the positive electrode plate and the negative electrode plate is effectively ensured, so that the technical effect is achieved.

When the fifth area S11 is relatively large, it indicates that the protruding portion 201 account for a large proportion, so that the positive electrode plate is prone to damage. When the fifth area S11 is relatively small, it indicates that the protruding portion 201 account for a small proportion, so that the supporting effect is not obvious, and the sufficient infiltration of the electrolyte will not be achieved.

With reference to FIG. 5 and FIG. 6, in an embodiment of the present disclosure, a head of the positive electrode plate includes a first void avoidance area 501, and in a length direction of the positive electrode plate (the x-axis shown in the figure), the first void avoidance area 501 has a third width M1. The head of the positive electrode plate includes an initial bending section and a secondary bending section, and in the length direction of the positive electrode plate, the third width M1=a width of the initial bending section±10 mm; or, the third width M1=a width of the initial bending section±a width of the secondary bending section±10 mm.

The first void avoidance area 501 prevents the head of the positive electrode plate from folding during insertion, so that a problem of structural instability caused by the unstable insertion of the head of the positive electrode plate during winding is solved.

A tail of the positive electrode plate includes a double-sided coating area and a single-sided coating area that are adjacent, two surfaces of the double-sided coating area are provided with active material layers respectively, one surface of the single-sided coating area is provided with the active material layer, and the double-sided coating area and the single-sided coating area have a boundary line 600. In the length direction of the positive electrode plate (the x-axis shown in the figure), there is a second void avoidance area 502 between the boundary line 600 and the protruding portion 201 and the second void avoidance area 502 has a fourth width M2 ranging from 2 mm to 30 mm.

The tail of the positive electrode plate has a region uncoated with active material layer, so that the foil in the region uncoated with active material layer is prevented from damage by providing the second void avoidance area 502.

Continuing referring to FIG. 5, in an embodiment of the present disclosure, in a width direction of the positive electrode plate (a y-axis shown in the figure), the positive electrode plate includes a first edge and a second edge which are opposite to each other, both the first edge and the second edge include a third void avoidance area 503 where the protruding portion 201 is not provided.

By providing the void avoidance area on the first edge and the second edge, problems that edge curling and poor interface uniformity of the first edge and the second edge caused by the rolling stress are solved.

Continuing referring to FIG. 5, in an embodiment of the present disclosure, the positive electrode plate includes a fourth void avoidance area 504 where the protruding portion 201 is not provided, the fourth void avoidance area 504 is constructed to set a tab 401, and the tab 401 is set in the fourth void avoidance area 504 through a tab protection adhesive 402. In the length direction of the positive electrode plate (the x-axis shown in the figure), there is a fifth width K between an edge of the electrode tab protection adhesive 402 and the protruding portion 201, and the fifth width K ranges from 2 mm to 30 mm.

By providing the fourth void avoidance area 504, the damage to the area of the positive electrode plate where the tab 401 is disposed due to rolling stress is avoided, so that welding stability of the tab 401 and interface uniformity is ensured.

In an embodiment of the present disclosure, a shape of a projection of the protruding portion 201 in the thickness direction of the positive electrode plate (the z-axis shown in the figure) includes a circle, a semicircle, an ellipse, a plum blossom shape or a polygon.

By setting the shape of the projection of the protruding portion 201, a sharp edge on the protrusion 201 is avoided, so that the separator is prevented from being punctured, and thus a safety incident of the battery cell caused by a short circuit between positive and negative electrodes and trigger is avoided.

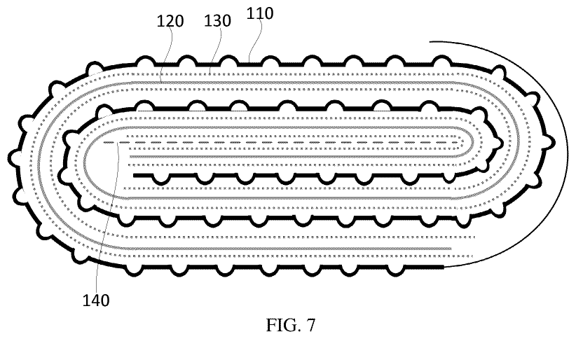

With reference to FIG. 7, an embodiment of the present disclosure also provides a battery cell which includes the positive electrode plate 110 described above. The battery cell also includes a negative electrode plate 120 and a separator 130 disposed between the positive electrode plate 110 and the negative electrode plate 120, and the positive electrode plate 110, the negative electrode plate 120 and the separator 130 are wound around a first central plane 140.

The battery cell includes a straight area and arc areas located at two opposite ends of the straight area, a surface of the first active material layer 200 faces away from the first central plane 140, and a surface of the second active material layer 300 faces towards the first central plane 140.

The separator 130 includes a substrate, a ceramic layer located on a side of the substrate and an adhesive layer located on the other side of the substrate, and the ceramic layer is disposed opposite to the protruding portion 201 of the positive electrode plate 110.

The substrate includes polyethylene, polypropylene, and a multilayer microporous film composited by the polyethylene and the polypropylene. The ceramic layer on the side of the substrate includes ceramics, polyvinylidene fluoride or array-arranged polymethyl methacrylate.

The ceramic layer opposite to the protruding portion 201 includes an inorganic ceramic particle coating layer, an inorganic ceramic particles and polyvinylidene fluoride coating layer, or an inorganic ceramic particles and polymethyl methacrylate and polyvinylidene fluoride coating layer. A content of the inorganic ceramic particles in the inorganic ceramic particles and polyvinylidene fluoride coating layer is ≥50%. The inorganic ceramic particles include one or more of α-Al₂O₃, γ-Al₂O₃, Al₂O₃, SiO₂, CeO₂, MgAl₂O₄, ZrO and TiO₂.

The ceramic layer opposite to the protruding portion 201 improves the safety of the battery cell. During a manufacturing process of the protruding portion 201, a sharp corner may form on the protruding portion of the active material layer, the ceramic layer may act as a protection to prevent the short circuit issue caused by the sharp corner piercing the separator.

At the same time, the adhesive layer on the other side of the substrate ensures proper adhesion at the interface, so that the lithium plating problem caused by poor adhesion at the interface is avoided.

The above-mentioned jelly roll provided by the present disclosure is described in detail in the following through specific embodiments. Specific differences between different embodiments are shown in Table 1 and Table 2.

### Embodiment 1

The preparation of a battery in the present embodiment includes the following steps.

### 1. Preparation of a Positive Electrode Plate 110

Lithium cobalt oxide, a conductive agent and polyvinylidene fluoride (PVDF) are mixed in a mass ratio of 97.6:1.4:1, and then N-methylpyrrolidone (NMP) is added, and they are stirred evenly to obtain a positive electrode slurry. The positive electrode slurry is uniformly coated on two opposite surfaces of a current collector 100 to form a first active material layer 200 and a second active material layer 300 on the current collector 100. A thickness of the current collector 100 is 1.5 μm, and a coating surface density is 0.01704 g/cm². After drying and rolling in sequence, a positive electrode plate 110 is prepared.

Among them, particle size distribution of active material layer particles in the first active material layer 200 and the second active material layer 300 is: Dv10: Dv50: Dv90=¼·5/9, Dv10=4.5 μm, Dv50=14 μm, and Dv90=28 μm.

The positive electrode plate 110 is rolled by an embossing roller to form a plurality of protruding portions 201 on the first active material layer 200 and a plurality of recessed portions 301 on the second active material layer 300, the plurality of recessed portions 301 correspond to the plurality of protruding portions 201. A first vertical distance H1 (a height of the protruding portion 201), a first thickness H2 (a thickness of the current collector 100), a second thickness H3 (a thickness of the first active material layer 200 or the second active material layer 300) and a second particle diameter D2 (Dv50) have a following relationship: (H1+Dv50)/(H2+2H3)=0.4.

A ratio of the first vertical distance H1 to a tensile strength M of the current collector 100 is: H1/M=0.15, a ratio of the first vertical distance H1 to an elongation at break N1 of the current collector 100 is: H1/N1=33, and an elongation rate of an aluminum foil N2=1.5%.

A radius of an arc-shaped outer surface of the protruding portion 201 is a first width R1, and a radius of an arc-shaped inner surface of the recessed portion 301 is a second width R2, R1/H1=200, and R1/R2=1.05.

An area of an arc-shaped outer surface of the protruding portion 201 is S1, an area of a projection of the arc-shaped outer surface in a thickness direction of the positive electrode plate is S2, and S1/S2=1.2. An area of an arc-shaped inner surface of the recessed portion 301 is S3, an area of a projection of the arc-shaped inner surface in the thickness direction of the positive electrode plate is S4, and S3/S4=1.3. A sum of projection areas of the plurality of protruding portions 201 in the thickness direction of the positive electrode plate is S11, a projection area of the positive electrode plate in the thickness direction of the electrode plate is S, and S11/S=0.6.

A center interval of projections of two adjacent protruding portions 201 in the thickness direction of the positive electrode plate is a first distance L1, a straight section between the two adjacent protruding portions 201 has a second distance L2 in a length direction or a width direction of the positive electrode plate, and L1/L2=1.5.

A first included angle a1 of the protruding portion 201 is 53°, a second included angle a2 of the recessed portion 301 is 38°, and a relationship between the first included angle a1 and the second included angle a2 is: a1−a2=15°.

### 2. Preparation of a Negative Electrode Plate 120

Silicon-containing artificial graphite, conductive carbon black, styrene-butadiene rubber and sodium carboxymethyl cellulose are mixed with a mass ratio of 97.2:0.5:1.3:1 in deionized water, and are stirred evenly to obtain a negative electrode slurry. Among them, a silicon content in the silicon-containing artificial graphite is 10%.

The negative electrode slurry is uniformly coated on two opposite surfaces of a negative current collector, and then after baking and rolling, a negative electrode plate 120 with a thickness of 220 μm is obtained, and a negative tab is weld on the negative electrode plate 120.

### 3. Preparation of a Separator 130

A separator 130 with a thickness of 9 μm is prepared by a substrate, ceramic and adhesive.

### 4. Preparation of Electrolyte

Electrolyte includes lithium salt LiPF₆ and a solvent, the solvent includes ethylene carbonate (EC), diethyl carbonate (DEC) and ethyl methyl carbonate (EMC), and a molar ratio of EC, the DEC, and the EMC is: DEC: EC: EMC=1:1:1.

### 5. Assembly

The positive electrode plate 110, the separator 130 and the negative electrode plate 120 are wound to obtain a battery cell, and then after packaging, baking, liquid injection, formation, and secondary sealing, the battery is obtained.

### Embodiment 2

Embodiment 2 is implemented with reference to Embodiment 1, with the difference that Dv10: Dv50: Dv90=1/5/9.5.

### Embodiment 3

Embodiment 3 is implemented with reference to Embodiment 1, with the difference that Dv10: Dv50: Dv90=Jan. 10, 2020.

### Embodiment 4

Embodiment 4 is implemented with reference to Embodiment 1, with the difference that Dv10: Dv50: Dv90=1/1/2.

### Embodiment 5

Embodiment 5 is implemented with reference to Embodiment 1, with the difference that Dv10=5 μm.

### Embodiment 6

Embodiment 6 is implemented with reference to Embodiment 1, with the difference that Dv10=9 μm.

### Embodiment 7

Embodiment 7 is implemented with reference to Embodiment 1, with the difference that Dv10=1 μm.

### Embodiment 8

Embodiment 8 is implemented with reference to Embodiment 1, with the difference that Dv50=15 μm.

### Embodiment 9

Embodiment 9 is implemented with reference to Embodiment 1, with the difference that Dv50=20 μm.

### Embodiment 10

Embodiment 10 is implemented with reference to Embodiment 1, with the difference that Dv50=10 μm.

### Embodiment 11

Embodiment 11 is implemented with reference to Embodiment 1, with the difference that Dv90=27 μm.

### Embodiment 12

Embodiment 12 is implemented with reference to Embodiment 1, with the difference that Dv90=34 μm.

### Embodiment 13

Embodiment 13 is implemented with reference to Embodiment 1, with the difference that Dv90=20 μm.

### Embodiment 14

Embodiment 14 is implemented with reference to Embodiment 1, with the difference that (H1+Dv50)/(H2+2H3)=0.45.

### Embodiment 15

Embodiment 15 is implemented with reference to Embodiment 1, with the difference that (H1+Dv50)/(H2+2H3)=0.9.

### Embodiment 16

Embodiment 16 is implemented with reference to Embodiment 1, with the difference that (H1+Dv50)/(H2+2H3)=0.05.

### Embodiment 17

Embodiment 17 is implemented with reference to Embodiment 1, with the difference that H1/M=0.23.

### Embodiment 18

Embodiment 18 is implemented with reference to Embodiment 1, with the difference that H1/M=0.4.

### Embodiment 19

Embodiment 19 is implemented with reference to Embodiment 1, with the difference that H1/M=0.02.

### Embodiment 20

Embodiment 20 is implemented with reference to Embodiment 1, with the difference that H1/N1=35.

### Embodiment 21

Embodiment 21 is implemented with reference to Embodiment 1, with the difference that H1/N1=79.

### Embodiment 22

Embodiment 22 is implemented with reference to Embodiment 1, with the difference that H1/N1=5.

### Embodiment 23

Embodiment 23 is implemented with reference to Embodiment 1, with the difference that N2=1.30%.

### Embodiment 24

Embodiment 24 is implemented with reference to Embodiment 1, with the difference that N2=3%.

### Embodiment 25

Embodiment 25 is implemented with reference to Embodiment 1, with the difference that N2=0.20%.

### Embodiment 26

Embodiment 26 is implemented with reference to Embodiment 1, with the difference that R1/H1=425.

### Embodiment 27

Embodiment 27 is implemented with reference to Embodiment 1, with the difference that R1/H1=900.

### Embodiment 28

Embodiment 28 is implemented with reference to Embodiment 1, with the difference that R1/H1=20.

### Embodiment 29

Embodiment 29 is implemented with reference to Embodiment 1, with the difference that R1/R2=1.15.

### Embodiment 30

Embodiment 30 is implemented with reference to Embodiment 1, with the difference that R1/R2=1.5.

### Embodiment 31

Embodiment 31 is implemented with reference to Embodiment 1, with the difference that R1/R2=1.

### Embodiment 32

Embodiment 32 is implemented with reference to Embodiment 1, with the difference that S1/S2=1.4.

### Embodiment 33

Embodiment 33 is implemented with reference to Embodiment 1, with the difference that S1/S2=2.

### Embodiment 34

Embodiment 34 is implemented with reference to Embodiment 1, with the difference that S1/S2=1.

### Embodiment 35

Embodiment 35 is implemented with reference to Embodiment 1, with the difference that S3/S4=1.4.

### Embodiment 36

Embodiment 36 is implemented with reference to Embodiment 1, with the difference that S3/S4=2.

### Embodiment 37

Embodiment 37 is implemented with reference to Embodiment 1, with the difference that S3/S4=1.

### Embodiment 38

Embodiment 38 is implemented with reference to Embodiment 1, with the difference that S11/S-0.5.

### Embodiment 39

Embodiment 39 is implemented with reference to Embodiment 1, with the difference that S11/S=1.

### Embodiment 40

Embodiment 40 is implemented with reference to Embodiment 1, with the difference that S11/S=0.05.

### Embodiment 41

Embodiment 41 is implemented with reference to Embodiment 1, with the difference that L1/L2=2.

### Embodiment 42

Embodiment 42 is implemented with reference to Embodiment 1, with the difference that L1/L2=3.

### Embodiment 43

Embodiment 43 is implemented with reference to Embodiment 1, except that L1/L2=1.

### Embodiment 44

Embodiment 44 is implemented with reference to Embodiment 1, with the difference that a1=45 degrees, a1−a2=7 degrees.

### Embodiment 45

Embodiment 45 is implemented with reference to Embodiment 1, with the difference that a1=100 degrees, a1−a2=62 degrees.

### Embodiment 46

Embodiment 46 is implemented with reference to Embodiment 1, with the difference that a1=−10 degrees, a1−a2=−48 degrees.

### Embodiment 47

Embodiment 47 is implemented with reference to Embodiment 1, with the difference that a2-45 degrees, a1−a2=8 degrees.

### Embodiment 48

Embodiment 48 is implemented with reference to Embodiment 1, with the difference that a2=100 degrees, a1−a2=−47 degrees.

### Embodiment 49

Embodiment 49 is implemented with reference to Embodiment 1, with the difference that a2=−10 degrees, a1−a2=63 degrees.

### Embodiment 50

Embodiment 50 is implemented with reference to Embodiment 1, with the difference that a1=60 degrees, a2=30 degrees, a1−a2=30 degrees.

### Embodiment 51

Embodiment 51 is implemented with reference to Embodiment 1, with the difference that a1=80 degrees, a2=30 degrees, a1−a2=50 degrees.

### Embodiment 52

Embodiment 52 is implemented with reference to Embodiment 1, with the difference that a1=40 degrees, a2=50 degrees, a1−a2=−10 degrees.

### Comparative Example 1

Comparative Example 1 is implemented with reference to Embodiment 1, with the difference that in Comparative Example 1, a particle diameter of lithium cobalt oxide particles in the first active material layer 200 and the second active material layer 300 is merely one type, and the lithium cobalt oxide particles are all large particles.

### Comparative Example 2

Comparative Example 2 is implemented with reference to Embodiment 1, with the difference that in Comparative Example 2, a particle diameter of lithium cobalt oxide particles in the first active material layer 200 and the second active material layer 300 is only one type, and the lithium cobalt oxide particles are all small particles.

TABLE 1

| | | | | | | (H1 + Dv50)/ | | |
|---|---|---|---|---|---|---|---|---|
| Type | Dv10/Dv50/Dv90 | Dv10 | | Dv50 | Dv90 | (H2 + 2H3) | H1/M | H1/N1 |
| Embodiment1 | 1/4.5/9 | 4.5 | μm | 14 μm | 28 μm | 0.4 | 0.15 | 33 |
| Embodiment2 | 1/5/9.5 | 4.5 | μm | 14 μm | 28 μm | 0.4 | 0.15 | 33 |
| Embodiment3 | 1/10/20 | 4.5 | μm | 14 μm | 28 μm | 0.4 | 0.15 | 33 |
| Embodiment4 | 1/1/2 | 4.5 | μm | 14 μm | 28 μm | 0.4 | 0.15 | 33 |
| Embodiment5 | 1/4.5/9 | 5 | μm | 14 μm | 28 μm | 0.4 | 0.15 | 33 |
| Embodiment6 | 1/4.5/9 | 9 | μm | 14 μm | 28 μm | 0.4 | 0.15 | 33 |
| Embodiment7 | 1/4.5/9 | 1 | μm | 14 μm | 28 μm | 0.4 | 0.15 | 33 |
| Embodiment8 | 1/4.5/9 | 4.5 | μm | 15 μm | 28 μm | 0.4 | 0.15 | 33 |
| Embodiment9 | 1/4.5/9 | 4.5 | μm | 20 μm | 28 μm | 0.4 | 0.15 | 33 |
| Embodiment10 | 1/4.5/9 | 4.5 | μm | 10 μm | 28 μm | 0.4 | 0.15 | 33 |
| Embodiment11 | 1/4.5/9 | 4.5 | μm | 14 μm | 27 μm | 0.4 | 0.15 | 33 |
| Embodiment12 | 1/4.5/9 | 4.5 | μm | 14 μm | 34 μm | 0.4 | 0.15 | 33 |
| Embodiment13 | 1/4.5/9 | 4.5 | μm | 14 μm | 20 μm | 0.4 | 0.15 | 33 |
| Embodiment14 | 1/4.5/9 | 4.5 | μm | 14 μm | 28 μm | 0.45 | 0.15 | 33 |
| Embodiment15 | 1/4.5/9 | 4.5 | μm | 14 μm | 28 μm | 0.9 | 0.15 | 33 |
| Embodiment16 | 1/4.5/9 | 4.5 | μm | 14 μm | 28 μm | 0.05 | 0.15 | 33 |
| Embodiment17 | 1/4.5/10 | 4.6 | μm | 14 μm | 28 μm | 0.4 | 0.23 | 33 |
| Embodiment18 | 1/4.5/11 | 4.7 | μm | 14 μm | 28 μm | 0.4 | 0.4 | 33 |
| Embodiment19 | 1/4.5/12 | 4.8 | μm | 14 μm | 28 μm | 0.4 | 0.02 | 33 |
| Embodiment20 | 1/4.5/13 | 4.9 | μm | 14 μm | 28 μm | 0.4 | 0.15 | 35 |
| Embodiment21 | 1/4.5/14 | 4.10 | μm | 14 μm | 28 μm | 0.4 | 0.15 | 79 |
| Embodiment22 | 1/4.5/15 | 4.11 | μm | 14 μm | 28 μm | 0.4 | 0.15 | 5 |
| Embodiment23 | 1/4.5/16 | 4.12 | μm | 14 μm | 28 μm | 0.4 | 0.15 | 33 |
| Embodiment24 | 1/4.5/17 | 4.13 | μm | 14 μm | 28 μm | 0.4 | 0.15 | 33 |
| Embodiment25 | 1/4.5/18 | 4.14 | μm | 14 μm | 28 μm | 0.4 | 0.15 | 33 |
| Embodiment26 | 1/4.5/19 | 4.15 | μm | 14 μm | 28 μm | 0.4 | 0.15 | 33 |
| Embodiment27 | 1/4.5/20 | 4.16 | μm | 14 μm | 28 μm | 0.4 | 0.15 | 33 |
| Embodiment28 | 1/4.5/21 | 4.17 | μm | 14 μm | 28 μm | 0.4 | 0.15 | 33 |
| Embodiment29 | 1/4.5/22 | 4.18 | μm | 14 μm | 28 μm | 0.4 | 0.15 | 33 |
| Embodiment30 | 1/4.5/23 | 4.19 | μm | 14 μm | 28 μm | 0.4 | 0.15 | 33 |
| Embodiment31 | 1/4.5/24 | 4.20 | μm | 14 μm | 28 μm | 0.4 | 0.15 | 33 |
| Embodiment32 | 1/4.5/25 | 4.21 | μm | 14 μm | 28 μm | 0.4 | 0.15 | 33 |
| Embodiment33 | 1/4.5/26 | 4.22 | μm | 14 μm | 28 μm | 0.4 | 0.15 | 33 |
| Embodiment34 | 1/4.5/27 | 4.23 | μm | 14 μm | 28 μm | 0.4 | 0.15 | 33 |
| Embodiment35 | 1/4.5/28 | 4.24 | μm | 14 μm | 28 μm | 0.4 | 0.15 | 33 |
| Embodiment36 | 1/4.5/29 | 4.25 | μm | 14 μm | 28 μm | 0.4 | 0.15 | 33 |
| Embodiment37 | 1/4.5/30 | 4.26 | μm | 14 μm | 28 μm | 0.4 | 0.15 | 33 |
| Embodiment38 | 1/4.5/31 | 4.27 | μm | 14 μm | 28 μm | 0.4 | 0.15 | 33 |
| Embodiment39 | 1/4.5/32 | 4.28 | μm | 14 μm | 28 μm | 0.4 | 0.15 | 33 |
| Embodiment40 | 1/4.5/33 | 4.29 | μm | 14 μm | 28 μm | 0.4 | 0.15 | 33 |
| Embodiment41 | 1/4.5/34 | 4.30 | μm | 14 μm | 28 μm | 0.4 | 0.15 | 33 |
| Embodiment42 | 1/4.5/35 | 4.31 | μm | 14 μm | 28 μm | 0.4 | 0.15 | 33 |
| Embodiment43 | 1/4.5/36 | 4.32 | μm | 14 μm | 28 μm | 0.4 | 0.15 | 33 |
| Embodiment44 | 1/4.5/37 | 4.33 | μm | 14 μm | 28 μm | 0.4 | 0.15 | 33 |
| Embodiment45 | 1/4.5/38 | 4.34 | μm | 14 μm | 28 μm | 0.4 | 0.15 | 33 |
| Embodiment46 | 1/4.5/39 | 4.35 | μm | 14 μm | 28 μm | 0.4 | 0.15 | 33 |
| Embodiment47 | 1/4.5/40 | 4.36 | μm | 14 μm | 28 μm | 0.4 | 0.15 | 33 |
| Embodiment48 | 1/4.5/41 | 4.37 | μm | 14 μm | 28 μm | 0.4 | 0.15 | 33 |
| Embodiment49 | 1/4.5/42 | 4.38 | μm | 14 μm | 28 μm | 0.4 | 0.15 | 33 |
| Embodiment50 | 1/4.5/43 | 4.39 | μm | 14 μm | 28 μm | 0.4 | 0.15 | 33 |
| Embodiment51 | 1/4.5/44 | 4.40 | μm | 14 μm | 28 μm | 0.4 | 0.15 | 33 |
| Embodiment52 | 1/4.5/45 | 4.41 | μm | 14 μm | 28 μm | 0.4 | 0.15 | 33 |
| Comparative1 | | | | | | | 0.15 | 33 |
| Comparative2 | | | | | | | 0.15 | 33 |

TABLE 2

| Type | N2 | R1/H1 | R1/R2 | S1/S2 | S3/S4 | S11/S | L1/L2 | a1 | a2 | a1 − a2 |
|---|---|---|---|---|---|---|---|---|---|---|
| Embodiment1 | 1.50% | 200 | 1.05 | 1.2 | 1.3 | 0.6 | 1.5 | 53 | 38 | 15 |
| Embodiment2 | 1.50% | 200 | 1.05 | 1.2 | 1.3 | 0.6 | 1.5 | 53 | 38 | 15 |
| Embodiment3 | 1.50% | 200 | 1.05 | 1.2 | 1.3 | 0.6 | 1.5 | 53 | 38 | 15 |
| Embodiment4 | 1.50% | 200 | 1.05 | 1.2 | 1.3 | 0.6 | 1.5 | 53 | 38 | 15 |
| Embodiment5 | 1.50% | 200 | 1.05 | 1.2 | 1.3 | 0.6 | 1.5 | 53 | 38 | 15 |
| Embodiment6 | 1.50% | 200 | 1.05 | 1.2 | 1.3 | 0.6 | 1.5 | 53 | 38 | 15 |
| Embodiment7 | 1.50% | 200 | 1.05 | 1.2 | 1.3 | 0.6 | 1.5 | 53 | 38 | 15 |
| Embodiment8 | 1.50% | 200 | 1.05 | 1.2 | 1.3 | 0.6 | 1.5 | 53 | 38 | 15 |
| Embodiment9 | 1.50% | 200 | 1.05 | 1.2 | 1.3 | 0.6 | 1.5 | 53 | 38 | 15 |
| Embodiment10 | 1.50% | 200 | 1.05 | 1.2 | 1.3 | 0.6 | 1.5 | 53 | 38 | 15 |
| Embodiment11 | 1.50% | 200 | 1.05 | 1.2 | 1.3 | 0.6 | 1.5 | 53 | 38 | 15 |
| Embodiment12 | 1.50% | 200 | 1.05 | 1.2 | 1.3 | 0.6 | 1.5 | 53 | 38 | 15 |
| Embodiment13 | 1.50% | 200 | 1.05 | 1.2 | 1.3 | 0.6 | 1.5 | 53 | 38 | 15 |
| Embodiment14 | 1.50% | 200 | 1.05 | 1.2 | 1.3 | 0.6 | 1.5 | 53 | 38 | 15 |
| Embodiment15 | 1.50% | 200 | 1.05 | 1.2 | 1.3 | 0.6 | 1.5 | 53 | 38 | 15 |
| Embodiment16 | 1.50% | 200 | 1.05 | 1.2 | 1.3 | 0.6 | 1.5 | 53 | 38 | 15 |
| Embodiment17 | 1.50% | 200 | 1.05 | 1.2 | 1.3 | 0.6 | 1.5 | 53 | 38 | 15 |
| Embodiment18 | 1.50% | 200 | 1.05 | 1.2 | 1.3 | 0.6 | 1.5 | 53 | 38 | 15 |
| Embodiment19 | 1.50% | 200 | 1.05 | 1.2 | 1.3 | 0.6 | 1.5 | 53 | 38 | 15 |
| Embodiment20 | 1.50% | 200 | 1.05 | 1.2 | 1.3 | 0.6 | 1.5 | 53 | 38 | 15 |
| Embodiment21 | 1.50% | 200 | 1.05 | 1.2 | 1.3 | 0.6 | 1.5 | 53 | 38 | 15 |
| Embodiment22 | 1.50% | 200 | 1.05 | 1.2 | 1.3 | 0.6 | 1.5 | 53 | 38 | 15 |
| Embodiment23 | 1.30% | 200 | 1.05 | 1.2 | 1.3 | 0.6 | 1.5 | 53 | 38 | 15 |
| Embodiment24 | 3% | 200 | 1.05 | 1.2 | 1.3 | 0.6 | 1.5 | 53 | 38 | 15 |
| Embodiment25 | 0.20% | 200 | 1.05 | 1.2 | 1.3 | 0.6 | 1.5 | 53 | 38 | 15 |
| Embodiment26 | 1.50% | 425 | 1.05 | 1.2 | 1.3 | 0.6 | 1.5 | 53 | 38 | 15 |
| Embodiment27 | 1.50% | 900 | 1.05 | 1.2 | 1.3 | 0.6 | 1.5 | 53 | 38 | 15 |
| Embodiment28 | 1.50% | 20 | 1.05 | 1.2 | 1.3 | 0.6 | 1.5 | 53 | 38 | 15 |
| Embodiment29 | 1.50% | 200 | 1.15 | 1.2 | 1.3 | 0.6 | 1.5 | 53 | 38 | 15 |
| Embodiment30 | 1.50% | 200 | 1.5 | 1.2 | 1.3 | 0.6 | 1.5 | 53 | 38 | 15 |
| Embodiment31 | 1.50% | 200 | 1 | 1.2 | 1.3 | 0.6 | 1.5 | 53 | 38 | 15 |
| Embodiment32 | 1.50% | 200 | 1.05 | 1.4 | 1.3 | 0.6 | 1.5 | 53 | 38 | 15 |
| Embodiment33 | 1.50% | 200 | 1.05 | 2 | 1.3 | 0.6 | 1.5 | 53 | 38 | 15 |
| Embodiment34 | 1.50% | 200 | 1.05 | 1 | 1.3 | 0.6 | 1.5 | 53 | 38 | 15 |
| Embodiment35 | 1.50% | 200 | 1.05 | 1.2 | 1.4 | 0.6 | 1.5 | 53 | 38 | 15 |
| Embodiment36 | 1.50% | 200 | 1.05 | 1.2 | 2 | 0.6 | 1.5 | 53 | 38 | 15 |
| Embodiment37 | 1.50% | 200 | 1.05 | 1.2 | 1 | 0.6 | 1.5 | 53 | 38 | 15 |
| Embodiment38 | 1.50% | 200 | 1.05 | 1.2 | 1.3 | 0.5 | 1.5 | 53 | 38 | 15 |
| Embodiment39 | 1.50% | 200 | 1.05 | 1.2 | 1.3 | 1 | 1.5 | 53 | 38 | 15 |
| Embodiment40 | 1.50% | 200 | 1.05 | 1.2 | 1.3 | 0.05 | 1.5 | 53 | 38 | 15 |
| Embodiment41 | 1.50% | 200 | 1.05 | 1.2 | 1.3 | 0.6 | 2 | 53 | 38 | 15 |
| Embodiment42 | 1.50% | 200 | 1.05 | 1.2 | 1.3 | 0.6 | 3 | 53 | 38 | 15 |
| Embodiment43 | 1.50% | 200 | 1.05 | 1.2 | 1.3 | 0.6 | 1 | 53 | 38 | 15 |
| Embodiment44 | 1.50% | 200 | 1.05 | 1.2 | 1.3 | 0.6 | 1.5 | 45 | 38 | 7 |
| Embodiment45 | 1.50% | 200 | 1.05 | 1.2 | 1.3 | 0.6 | 1.5 | 100 | 38 | 62 |
| Embodiment46 | 1.50% | 200 | 1.05 | 1.2 | 1.3 | 0.6 | 1.5 | −10 | 38 | −48 |
| Embodiment47 | 1.50% | 200 | 1.05 | 1.2 | 1.3 | 0.6 | 1.5 | 53 | 45 | 8 |
| Embodiment48 | 1.50% | 200 | 1.05 | 1.2 | 1.3 | 0.6 | 1.5 | 53 | 100 | −47 |
| Embodiment49 | 1.50% | 200 | 1.05 | 1.2 | 1.3 | 0.6 | 1.5 | 53 | −10 | 63 |
| Embodiment50 | 1.50% | 200 | 1.05 | 1.2 | 1.3 | 0.6 | 1.5 | 60 | 30 | 30 |
| Embodiment51 | 1.50% | 200 | 1.05 | 1.2 | 1.3 | 0.6 | 1.5 | 80 | 30 | 50 |
| Embodiment52 | 1.50% | 200 | 1.05 | 1.2 | 1.3 | 0.6 | 1.5 | 40 | 50 | −10 |
| Comparative1 | 1.50% | 200 | 1.05 | 1.2 | 1.3 | 0.6 | 1.5 | 40 | 50 | −10 |
| Comparative2 | 1.50% | 200 | 1.05 | 1.2 | 1.3 | 0.6 | 1.5 | 40 | 50 | −10 |

Relevant performance of the batteries in the above embodiments and comparative examples was tested, and testing results are recorded in Table 3, and testing methods are as follows:

### 1. Electrolyte Retention Amount Test

An electrolyte retention amount is an amount of the electrolyte finally retained in a lithium-ion battery. In order to ensure consumption of the electrolyte during the formation of the lithium-ion battery, a certain amount of the electrolyte is usually injected in excess, and the excess electrolyte is extracted after formation. The measurement is carried out by weighing: an injection amount m1, an extraction amount m2, and the electrolyte retention amount=m1-m2.

### 2. Appearance status of the current collector 100 and the positive electrode plate 110

A shape of the protruding portions 201 was observed by using a 3D microscope, and damage conditions of the current collector 100 and the positive electrode plate 110 was observed by using the 3D microscope.

### 3. Test of Tensile Strength of a Current Collector

The test was carried out by using a vertical tensile testing machine. The current collectors obtained from the above embodiments and comparative examples were respectively fixed on clamps at two ends of the tensile machine, the clamps were aligned, a button of the vertical tensile testing device was pressed to start the device, the device is moved at a speed of 10 mm/s until the current collector broke, and then tensile data were read.

### 4. Lithium Plating on a Negative Electrode Plate

After a battery cell expansion rate test was respectively performed on the batteries obtained from the above embodiments and comparative examples, the batteries obtained from the above embodiments and comparative examples were fully charged respectively, and then were disassembled in the environment of a dry room to observe whether lithium plating occurred on the negative electrode plate and a degree of the lithium plating. The degree of the lithium plating is classified into slight lithium plating and severe lithium plating. The slight lithium plating refers to gray or gray-black coloration at the interface where the lithium plating occurs, and the severe lithium plating refers to silver-white coloration at the interface where the lithium plating occurs, indicating a larger amount of the lithium plating.

### 5. Infiltration Improvement Effect Test

After the battery being stored at a room temperature (25° C.) for 24 hours, it was disassembled to observe an infiltration condition of a separator, and then an area of a wetted portion was estimated and compared, which is classified into three levels: significant (the infiltration area ranges from 60% to 100%), moderate (the infiltration area ranges from 30% to 60%) and slight (the infiltration area ranges from 0% to 30%). An unwetted area usually has an irregular water-like pattern boundary, and a difference a size of an area thereof may be directly observed by visual inspection.

TABLE 3

| | Current | | Degree of | Degree of | | | Negative |
|---|---|---|---|---|---|---|---|
| | collector | | damage to | damage to | Electrolyte | Infiltration | electrode |
| | tensile | | current | electrode | retention | improvement | lithium plating |
| Type | strength | | collector | plate | amount | effect | condition |
| Embodiment1 | 168 | MPa | None | None | 8.27 | Significant | None |
| Embodiment2 | 161 | MPa | None | None | 8.24 | Significant | None |
| Embodiment3 | 48 | MPa | Slight Damage | Slight Damage | 8.11 | Slight | Slight lithium |
| | | | | | | | plating |
| Embodiment4 | 49 | MPa | Slight Damage | None | 8.12 | Slight | None |
| Embodiment5 | 164 | MPa | None | None | 8.26 | Significant | None |
| Embodiment6 | 50 | MPa | Slight Damage | Slight Damage | 8.23 | Significant | Slight lithium |
| | | | | | | | plating |
| Embodiment7 | 49 | MPa | Slight Damage | None | 8.24 | Significant | None |
| Embodiment8 | 157 | MPa | None | None | 8.26 | Significant | None |
| Embodiment9 | 51 | MPa | Slight Damage | Slight Damage | 8.13 | Slight | Slight lithium |
| | | | | | | | plating |
| Embodiment10 | 48 | MPa | Slight Damage | None | 8.12 | Slight | None |
| Embodiment11 | 160 | MPa | None | None | 8.24 | Significant | None |
| Embodiment12 | 50 | MPa | Slight Damage | Slight Damage | 8.12 | Slight | Slight lithium |
| | | | | | | | plating |
| Embodiment13 | 49 | MPa | Slight Damage | None | 8.11 | Slight | None |
| Embodiment14 | 157 | MPa | None | None | 8.25 | Significant | None |
| Embodiment15 | 51 | MPa | Slight Damage | Slight Damage | 8.11 | Slight | Slight lithium |
| | | | | | | | plating |
| Embodiment16 | 50 | MPa | Slight Damage | None | 8.12 | Slight | None |
| Embodiment17 | 161 | MPa | None | None | 8.24 | Significant | None |
| Embodiment18 | 160 | MPa | None | Slight Damage | 8.26 | Significant | Slight lithium |
| | | | | | | | plating |
| Embodiment19 | 160 | MPa | None | None | 8.12 | Slight | None |
| Embodiment20 | 163 | MPa | None | None | 8.24 | Significant | None |
| Embodiment21 | 150 | MPa | None | Slight Damage | 8.17 | moderate | Slight lithium |
| | | | | | | | plating |
| Embodiment22 | 160 | MPa | None | None | 8.12 | Slight | None |
| Embodiment23 | 167 | MPa | None | None | 8.23 | Significant | None |
| Embodiment24 | 167 | MPa | None | None | 8.25 | Significant | None |
| Embodiment25 | 50 | MPa | Slight Damage | None | 8.23 | Significant | None |
| Embodiment26 | 164 | MPa | None | None | 8.21 | Significant | None |
| Embodiment27 | 158 | MPa | None | None | 8.11 | Slight | None |
| Embodiment28 | 150 | MPa | None | Severe damage | 8.18 | moderate | Slight lithium |
| | | | | | | | plating |
| Embodiment29 | 162 | MPa | None | None | 8.23 | Significant | None |
| Embodiment30 | 161 | MPa | None | Severe damage | 8.12 | Slight | Slight lithium |
| | | | | | | | plating |
| Embodiment31 | 158 | MPa | None | None | 8.09 | Slight | None |
| Embodiment32 | 161 | MPa | None | None | 8.23 | Significant | None |
| Embodiment33 | 163 | MPa | Slight Damage | Severe damage | 8.25 | Significant | Slight lithium |
| | | | | | | | plating |
| Embodiment34 | 158 | MPa | None | None | 8.1 | Slight | None |
| Embodiment35 | 165 | MPa | None | None | 8.23 | Significant | None |
| Embodiment36 | 163 | MPa | Slight Damage | Severe damage | 8.26 | Significant | Slight lithium |
| | | | | | | | plating |
| Embodiment37 | 160 | MPa | None | None | 8.11 | Slight | None |
| Embodiment38 | 164 | MPa | None | None | 8.25 | Significant | None |
| Embodiment39 | 159 | MPa | None | Severe damage | 8.26 | Significant | Slight lithium |
| | | | | | | | plating |
| Embodiment40 | 160 | MPa | None | None | 8.11 | Slight | None |
| Embodiment41 | 165 | MPa | None | None | 8.23 | Significant | None |
| Embodiment42 | 162 | MPa | None | Severe damage | 8.24 | Significant | Slight lithium |
| | | | | | | | plating |
| Embodiment43 | 161 | MPa | None | None | 8.09 | Slight | None |
| Embodiment44 | 164 | MPa | None | None | 8.26 | Significant | None |
| Embodiment45 | 162 | MPa | None | Severe damage | 8.23 | Significant | Slight lithium |
| | | | | | | | plating |
| Embodiment46 | 160 | MPa | None | None | 8.08 | Slight | None |
| Embodiment47 | 166 | MPa | None | None | 8.25 | Significant | None |
| Embodiment48 | 161 | MPa | None | Severe damage | 8.23 | Significant | Slight lithium |
| | | | | | | | plating |
| Embodiment49 | 159 | MPa | None | None | 8.11 | Slight | None |
| Embodiment50 | 165 | MPa | None | None | 8.25 | Significant | None |
| Embodiment51 | 161 | MPa | None | Severe damage | 8.18 | moderate | Slight lithium |
| | | | | | | | plating |
| Embodiment52 | 160 | MPa | None | Severe damage | 8.17 | moderate | Slight lithium |
| | | | | | | | plating |
| Comparative1 | 50 | MPa | Severe damage | Severe damage | 8.11 | Slight | Slight lithium |
| | | | | | | | plating |
| Comparative2 | 49 | MPa | None | None | 8.09 | Slight | None |

As shown in Table 3, Comparative Example 1 has a low electrolyte retention amount and poor infiltration effect, moreover, the current collector and the electrode plate are severely damaged, the reason lies in that a depth of the recessed portion 301 cannot be pressed down due to large particles, so that a height of the protruding portion 201 is insufficient, and thus the infiltration effect is poor. The large particles are prone to breaking under compression. If compressing excessive deep, the particles will also squeeze and crack the current collector 100. In Comparative Example 2, the electrolyte retention amount is low and the infiltration effect is poor, the reason lies in that small particles have a low gram capacity and a smaller maximum compaction density, so that the height of the protruding portion 201 is insufficient.

An electrolyte retention amount of Embodiment 1 is higher than that of Comparative Example 1 and Comparative Example 2, and there is no damage to the current collector and the electrode plate in Embodiment 1. This indicates that there are large and small particles mixed in the active material layers, so that the small particles are allowed to slide to two sides and be filled between the large particles under a force, and thus not only the particles are prevented from breaking, but also the current collector is protected from being torn.

From Embodiments 2 to 4, it may be seen that, when Dv50 and Dv90 are relatively large among Dv10, Dv50 and Dv90, the electrolyte retention amount is low and the infiltration effect is not obvious. Moreover, the current collector and the electrode plate are severely damaged. This indicates that the depth of the recessed portion 301 cannot be pressed down due to the large particles, so that a height of the protruding portion 201 is insufficient, and thus the infiltration effect is poor. In addition, the particles are prone to breaking and will also squeeze and crack the current collector 100. When Dv50 and Dv90 are relatively small among Dv10, Dv50 and Dv90, there is a higher proportion of the small particles, the small particles have the low gram capacity and the smaller maximum compaction density, so that the height of the protruding portion 201 is insufficient, and thus the electrolyte retention amount is low and the infiltration effect is poor. At the same time, when the small particles slide to two sides under the force, there is an insufficient filling space, so that the current collector 100 will be torn.

From Embodiments 5 to 7, it may be seen that, when Dv10 is greater than 8 μm, a particle diameter of small particles is excessively large, so that the small particles cannot be filled between large particles when the small particles slide to both sides, and thus the particles are prone to breaking. Moreover, the particles will also squeeze and crack the current collector 100, so that causing severe damage to the current collector 100 and the electrode plate. When Dv10 is less than 2 μm, the particle diameter of the small particles is excessively small, the presence of the small particles is meaningless, so that an effect brought by mixing the large and the small particles will not exist, thereby the current collector 100 will be torn, and thus causing severe damage to the current collector 100.

From Embodiments 8 to 13, it may be seen that, when Dv50 is greater than 19 μm and Dv90 is greater than 32 μm, a particle diameter of the large particles is excessively large, so that the depth of the recessed portion 301 cannot be pressed down due to the large particles, so that the height of the protruding portion 201 is insufficient, and thus the infiltration effect is poor. The particles are prone to breaking, and the particles will also squeeze and crack the current collector 100, so that causing severe damage to the current collector 100. When Dv50 is less than 11 μm and Dv90 is less than 22 μm, the particle diameter of the small particles is excessively small, the effect brought by mixing large and small particles will not exist, so that the current collector 100 will be torn, and thus causing severe damage to the current collector 100.

From Embodiments 14 to 16, it may be seen that, when (H1+Dv50)/(H2+2H3) is greater than 0.8, it indicates that the height of the protruding portion 201 is excessively high, or the particle diameter of the large particles is excessively large, which is prone to causing the electrode plate to damage and the particles to break. When (H1+Dv50)/(H2+2H3) is less than 0.1, it indicates that the height of the protruding portion 201 is excessively small, or Dv50 is excessively small, so that the maximum compaction density of the material is excessively small, thereby the height of the protruding portion 201 is difficult to be ensured, and thus resulting in poor infiltration effect.

From Embodiments 17 to 19, it may be seen that, when H1/M is greater than 0.4, it indicates that the height of the protruding portion 201 is excessively high, so that of the foil is excessively stretched, and thus the electrode plate is prone to being damaged. When H1/M is less than 0.05, it indicates that the height of the protruding portion 201 is excessively small, resulting in poor infiltration effect.

From Embodiments 20 to 22, it may be seen that when H1/N1 is greater than 60, it indicates that the height of the protruding portion 201 is excessively high, so that the foil is excessively stretched, and thus the electrode plate is prone to be damaged. When H1/N1 is less than 10, it indicates that the height of the protruding portion 201 is excessively small, resulting in poor infiltration effect.

From Embodiments 23 to 25, it may be seen that when embossing the particles will compress the aluminum foil, the elongation rate N2 of the aluminum foil is set to range from 0.5% to 2% to avoid breakage of the aluminum foil. When the elongation rate N2 is less than 0.5%, the current collector 100 will be torn, so that the current collector 100 is severely damaged.

From Embodiments 26 to 28, it may be seen that, R1/H1 is able to make the electrode plate and the separator have an appropriate gap therebetween in a wide range, that is, the protruding portion 201 has an appropriate deformation space and a liquid storage space to provide sufficient structural support, so that the benefit effect is maximized. When R1/H1 is greater than 800, a projection diameter of the protruding portion 201 is small, the height of the protruding portion 201 is high, so that the protruding portion 201 is excessive sharp, and thus it is easy to cause damage to the electrode plate. When R1/H1 is less than 50, the projection diameter of the protruding portion 201 is large, the height of the protruding portion 201 is low, so that the structural support of the protruding portion 201 is insufficient, thereby the protruding portion 201 is prone to excessive deformation under the compressive force and the elongation force during the manufacturing process, and thus the protruding portion 201 tends to be flattened. Therefore, it causes the collapse of the protruding portion 201, so that the electrolyte infiltration, the amount of liquid storage and the negative electrode expansion will not be improved.

From Embodiments 29 to 31, it may be seen that, when the ratio of the first radius R1 and the second radius R2 is greater than 1.3, the electrode plate is easily damaged, and there will be slight lithium plating on the negative electrode, the electrolyte retention amount is low, and the infiltration effect is poor. The reason lies in that a volume of the protruding portion 201 is excessively large, and there are cracks at a highest point of the protruding portion 201. However, a volume of the recessed portion 301 is excessively small, a structure composed of the protruding portion 201 and the recessed portion 301 is prone to collapse, so that the structure composed of the protruding portion 201 and the recessed portion 301 has a small deformation space, and a space for accommodating the electrolyte is insufficient. Conversely, when the ratio of the first radius R1 and the second radius R2 is less than 1.01, the volume of the protruding portion 201 is excessively small, and the volume of the recessed portion 301 is excessively large, the structure composed of the protruding portion 201 and the recessed portion 301 is prone to collapse, the structure composed of the protruding portion 201 and the recessed portion 301 has a small deformation space, and a space for accommodating the electrolyte is insufficient.

From Embodiments 32 to 37, it may be seen that, when S1/S2 is greater than 1.8, an outer surface area of the protruding portion 201 is large, but the projection area of the protruding portion 201 is small, which indicates that the height of the protruding portion 201 is high, so that it is prone to cause the electrode plate to damage and the particles to break. When S1/S2 is less than 1.05, the outer surface area of the protruding portion 201 is small, but the projection area of the protruding portion 201 is large, which indicates that the height of the protruding portion 201 is low, so that the supporting effect is not obvious, and the electrolyte infiltration effect is poor. When S3/S4 is greater than 1.8, an outer surface area of the recessed portion 301 is large, but a projection area of the recessed portion 301 is small, which indicates that the height of the recessed portion 301 is high, which is prone to causing the electrode plate to damage and the particles to break. When S3/S4 is less than 1.1, the outer surface area of the recessed portion 301 is small, but the projection area of the recessed portion 301 is large, which indicates that the height of the recessed portion 301 is low, so that an electrolyte infiltration space is small, and thus the electrolyte infiltration effect is poor.

From Embodiments 38 to 40, it may be seen that, when S11/S is greater than 0.95, it indicates that the protruding portions 201 account for a relatively large proportion, and the electrode plate is prone to damage. When S11/S is less than 0.1, it indicates that the protruding portions 201 account for a relatively small proportion, so that the supporting effect is not obvious, and thus the electrolyte infiltration effect is poor.

From Embodiments 41 to 43, it may be seen that, when L1/L2 is greater than 3, the spacing between the protruding portions 201 is excessively small, and the electrode plate is prone to damage. When L1/L2 is less than 1.05, the spacing between the protruding portions 201 is excessively large, so that the protruding portions 201 is excessively sparse, thereby the support force is insufficient, and thus the electrolyte infiltration effect is poor.

From Embodiments 44 to 46, it may be seen that, when the first included angle a1 is greater than 90 degrees, and the relationship (a1−a2) of the first included angle a1 and the second included angle a2 is greater than 40 degrees, the electrode plate will be damaged, the electrolyte retention amount is low, and the infiltration effect is poor. The reason lies in that a tilt angle at a connection position of the protruding portion 201 and the straight section is excessively large, causing excessive bending, and thus resulting in the electrode plate is damaged. At the same time, when an inclination angle of the protruding portion 201 relative to the recessed portion 301 is excessively large, and the structure composed of the protruding portion 201 and the recessed portion 301 is unstable, so that it is prone to collapse when subjected to the compressive stress, and thus the electrolyte infiltration effect is poor. When the first included angle a1 is less than 0 degree, and the relationship (a1−a2) between the first included angle a1 and the second included angle a2 is less than 0 degree, it indicates that the protruding portion 201 is shorter, so that the protruding portion 201 is an ineffective protruding portion, and thus the supporting effect is poor and the electrolyte infiltration effect is poor.

From Embodiments 47 to 49, it may be seen that, when the second included angle a2 is greater than 90 degrees, and the relationship (a1−a2) between the first included angle a1 and the second included angle a2 is less than 0 degree, the electrode plate is damaged. The reason lies in that an inclination angle at the connection position between the recessed portion 301 and the straight section is excessively large, causing excessive bending, and thus resulting in the electrode plate is damaged. At the same time, when an inclination angle of the recessed portion 301 relative to the protruding portion 201 is excessively large, the structure composed of the protruding portion 201 and the recessed portion 301 is unstable, which is prone to collapse when subjected to the compressive stress. When the second included angle a2 is less than 0 degree, and the relationship (a1−a2) between the first included angle a1 and the second included angle a2 is greater than 40 degrees, the inclination angle of the recessed portion 301 relative to the protruding portion 201 is excessively small, and a depth of the recessed portion 301 is shallow, so that electrolyte infiltration effect is poor.

From Embodiments 50 to 52, it may be seen that, when the first included angle a1 and the second included angle a2 both range from 0 degree to −90 degrees, but (a1−a2) is greater than 40 degrees, it indicates that the inclination angle at the connection position of the protruding portion 201 and the straight section is excessively large, so that a highest protruding point of the protruding portion 201 is prone to breakage, and thus resulting in the electrode plate is damaged. When the first included angle a1 and the second included angle a2 range from 0 degrees to −90 degrees, but (a1−a2) is less than 0 degree, it indicates that the inclination angle at the connection position of the recessed portion 301 and the straight section is excessively large, resulting in excessive bending, so that the electrode plate is damaged.

In this specification, each embodiment is described in a progressive manner, with each embodiment focusing on differences from other embodiments. Same and similar portions between various embodiments may be referred to each other.

It should be noted that, “one embodiment”, “embodiments”, “exemplary embodiment”, “some embodiments” and the like mentioned in the specification indicate that the described embodiment may include a specific feature, structure or characteristic, but not every embodiment necessarily includes such specific feature, structure or characteristic. Furthermore, such phrases do not necessarily refer to the same embodiment. In addition, when describing a specific feature, structure or characteristic in conjunction with an embodiment, it is within the knowledge of those skilled in the art to implement such feature, structure or characteristic in conjunction with other embodiments that are explicitly or not explicitly described.

In general, terms should be understood at least partially based on the context in which they are used. For example, depending at least in part on the context, the term “one or more” as used in the specification may be used for describing any feature, structure or characteristic in a singular sense, or may be used for describing a combination of features, structures or characteristics in a plural sense. Similarly, terms such as “one” or “the” may also be understood, at least partially based on the context, conveying either a singular connotation or a plural connotation.

It should be easily understood that, the phrases “on . . . “,” . . . over” and “above . . . ” shall be interpreted in their broadest sense in the present disclosure, so that “on . . . ” not merely means “directly on something”, but also includes the meaning of “on something” with an intermediate feature or layer therebetween, and “ . . . over” or “above . . . ” not only includes the meaning of “over something” or “above something”, but also includes the meaning of “over something” or “above something” with no intermediate feature or layer therebetween (that is, directly on something).

In addition, spatially relative terms such as “below”, “under”, “lower”, “above” and “upper” and the like may be used herein for ease of illustration, to describe a relationship of an element or feature with respect to other elements or features as illustrated in the figures. The spatially relative term is intended to include different orientations of a device in use or in operation in addition to the orientation shown in the figures. The device may have other orientations (rotated 90 degrees or in other orientations), and the spatially relative terms used in the text may likewise be interpreted accordingly.

Finally, it should be noted that, the above embodiments are merely used for illustrating the technical solutions of the present disclosure, and do not intend to limit them. Although the present disclosure is described in detail with reference to the above embodiments, those with ordinary skill in the art should understand that, they can still modify the technical solutions described in the above embodiments, or substitute some or all of the technical features equally. These modifications or substitutions do not make the essence of the corresponding technical solutions depart from the scope of the technical solutions of the various embodiments of the present disclosure.

What is claimed is:

1. A positive electrode plate, comprising a current collector, a first active material layer and a second active material layer,
the current collector having a first surface and a second surface opposite to each other along a thickness direction of the positive electrode plate, the first active material layer being disposed on the first surface, and the second active material layer being disposed on the second surface;
the first active material layer being provided with a plurality of protruding portions, and the second active material layer being provided with a plurality of recessed portions corresponding to the protruding portions; and
both the first active material layer and the second active material layer comprising a plurality of active material particles, and the plurality of active material particles comprising at least one of lithium iron phosphate, lithium manganese iron phosphate, lithium manganese phosphate, Liₐ₁Coₓ₁M1ₖ₁O₂ and Liₐ₂Niₓ₂CO_{y2}D_{z2}M2ₖ₂O₂,
wherein, 0.85≤a1≤1.1, 0.85≤a2≤1.1, 0.85≤x1≤1.05, 0.3≤x2≤0.98, 0≤y2≤ 0.5, 0≤ z2≤0.5, 0≤k1≤0.15, 0≤k2≤0.15,
D comprises at least one of Mn and Al,
M1 comprises at least one of Al, Mg, Ti, Zr, Y, La, W, B, Nb and Mn,
M2 comprises at least one of Mg, Ti, Zr, Y, La, W, B and Nb, and
a particle size distribution of the plurality of active material layer particles satisfies: Dv10: Dv50: Dv90=1: (2˜8): (3˜16).

2. The positive electrode plate according to claim 1, wherein,
Dv10 ranges from 2 μm to 8 μm;
Dv50 ranges from 11 μm to 19 μm; and
Dv90 ranges from 22 μm to 32 μm.

3. The positive electrode plate according to claim 1, wherein,
the protruding portion has a first intersection point, and the first intersection point intersects with a plane where a surface of the first active material layer is located;
in the thickness direction of the positive electrode plate, the first intersection point and a highest protruding point of the protruding portion have a first vertical distance H1, H1 ranges from 3μ m to 40 μm;
a thickness of the current collector is a first thickness H2, H2 ranges from 6 μm to 20 μm;
in the thickness direction of the positive electrode plate, both the first active material layer and the second active material layer have a second thickness H3, H3 ranges from 30 μm to 150 μm; and
the first vertical distance H1, the first thickness H2, the second thickness H3, and Dv50 have a following relationship: (H1+Dv50)/(H2+2H3)=0.1˜0.8.

4. The positive electrode plate according to claim 3, wherein,
along a width direction of the positive electrode plate and a length direction of the positive electrode plate, and a tensile strength M of the current collector is ≥50 MPa; and
the first vertical distance H1 and the tensile strength M have a following relationship: 0.05≤H1/M≤0.4.

5. The positive electrode plate according to claim 3, wherein, the current collector has an elongation at break N1, and the elongation at break N1≥2%.

6. The positive electrode plate according to claim 5, wherein, the first vertical distance H1 and the elongation at break N1 have a following relationship: 10≤H1/N1≤60.

7. The positive electrode plate according to claim 1, wherein,
the current collector comprises an aluminum foil, the aluminum foil has an elongation rate N2, and the elongation rate N2 ranges from 0.5% to 2%.

8. The positive electrode plate according to claim 3, wherein,
the protruding portion has an arc-shaped outer surface, the arc-shaped outer surface is located on the first active material layer, and a projection of the arc-shaped outer surface in the thickness direction of the positive electrode plate has a first width R1;
the recessed portion has an arc-shaped inner surface, the arc-shaped inner surface is located on the second active material layer, and a projection of the arc-shaped inner surface in the thickness direction of the positive electrode plate has a second width R2; and
the first width R1 and the second width R2 have a following relationship: R1/R2=1.01˜1.3.

9. The positive electrode plate according to claim 8, wherein, the first width R1 and the first vertical distance H1 have a following relationship: R1/H1=50˜800.

10. The positive electrode plate according to claim 8, wherein,
the arc-shaped outer surface has a first area S1, and the projection of the arc-shaped outer surface in the thickness direction of the positive electrode plate has a second area S2, and
the first area S1 and the second area S2 have a following relationship:
$$S 1 / S 2 = 1.05 ∼ 1.8 .$$

11. The positive electrode plate according to claim 8, wherein, the arc-shaped inner surface has a third area S3, and the projection of the arc-shaped inner surface in the thickness direction of the positive electrode plate has a fourth area S4, and the third area S3 and the fourth area S4 have a following relationship:
$$S 3 / S 4 = 1.1 ∼ 1.8 .$$

12. The positive electrode plate according to claim 1, wherein,
a center interval of projections of two adjacent protruding portions in the thickness direction of the positive electrode plate is a first distance L1;
there is a straight section between two adjacent protruding portions, and the straight section has a second distance L2 in a length direction of the positive electrode plate or a width direction of the positive electrode plate; and
the first distance L1 and the second distance L2 have a following relationship: L1/L2=1.05˜3.

13. The positive electrode plate according to claim 3, wherein,
a first tangent line is tangent to the first intersection point, and an included angle between the first tangent line and the plane where the surface of the first active material layer is located is a first included angle a1;
the recessed portion has a second intersection point, and the second intersection point intersects with a plane where a surface of the second active material layer is located;
a second tangent line is tangent to the second intersection point, and an included angle between the second tangent line and a horizontal plane where the surface of the second active material layer is located is a second included angle a2;
the first included angle a1 and the second included angle a2 have following relationships: a1−a2=0°˜40°;
the first included angle a1 ranges from 0° to 90°; and
the second included angle a2 ranges from 0° to 90°.

14. The positive electrode plate according to claim 1, wherein,
a sum of projection areas of the plurality of protruding portions in the thickness direction of the positive electrode plate is a fifth area S11, a projection area of the electrode plate in the thickness direction of the electrode plate is a sixth area S, and the fifth area S11 and the sixth area S have a following relationship: S11/S=0.1˜0.95.

15. The positive electrode plate according to claim 1, wherein,
a head of the positive electrode plate comprises a first void avoidance area, and in a length direction of the positive electrode plate, the first void avoidance area has a third width M1; and
the head of the positive electrode plate comprises an initial bending section, and in the length direction of the positive electrode plate, the third width M1=a width of the initial bending section ±10 mm.

16. The positive electrode plate according to claim 1, wherein, the head of the positive electrode plate comprises an initial bending section and a secondary bending section, and in the length direction of the positive electrode plate, the third width M1=a width of the initial bending section±a width of the secondary bending section±10 mm.

17. The positive electrode plate according to claim 1, wherein, a tail of the positive electrode plate comprises a double-sided coating area and a single-sided coating area that are adjacent, two surfaces of the double-sided coating area are provided with active material layers respectively, one surface of the single-sided coating area is provided with the active material layer, and the double-sided coating area and the single-sided coating area have a boundary line; and
in the length direction of the positive electrode plate, there is a second void avoidance area between the boundary line and the protruding portion, and the second void avoidance area has a fourth width M2 ranging from 2 mm to 30 mm.

18. The positive electrode plate according to claim 1, wherein,
a shape of a projection of the protruding portion in the thickness direction of the positive electrode plate comprises a circle, a semicircle, an ellipse, a plum blossom shape or a polygon.

19. A battery cell, comprising the positive electrode plate according to claim 1, and further comprising a separator and a negative electrode plate;
the separator comprising a substrate, a ceramic layer located on a side of the substrate and an adhesive layer located on the other side of the substrate, and the ceramic layer being disposed opposite to the protruding portion of the positive electrode plate.

20. The battery cell according to claim 19, wherein the ceramic layer is an inorganic ceramic particle coating layer, an inorganic ceramic particles and polyvinylidene fluoride coating layer or an inorganic ceramic particles and polymethyl methacrylate and polyvinylidene fluoride coating layer;
a content of the inorganic ceramic particle in the ceramic layer is ≥50%; and
the inorganic ceramic particle comprises one or more of α-Al₂O₃, γ-Al₂O₃, Al₂O₃, SiO₂, CeO₂, MgAl₂O₄, ZrO and TiO₂.
